(19) United States
(12) Patent Application Publication
(10) Pub. No.: US 2025/0016556 A1
(43) Pub. Date: Jan. 9, 2025

(54) SECRET KEY EXTRACTION FOR PHYSICAL LAYER PROTECTION IN A WIRELESS COMMUNICATIONS SYSTEM

(71) Applicant: QUALCOMM INCORPORATED, San Diego, CA (US)

(72) Inventors: Ahmed Elshafie, San Diego, CA (US); Muhammad Sayed Khairy Abdelghaffar, San Jose, CA (US); Alexandros Manolakos, Athens (GR); Hung Dinh Ly, San Diego, CA (US)

(21) Appl. No.: 18/707,035

(22) PCT Filed: Nov. 14, 2022
(86) PCT No.: PCT/US2022/049861

§ 371 Date: May 2, 2024

(30) Foreign Application Priority Data
Dec. 6, 2021 (GR) 20210100849

(51) Int. Cl. H04W 12/041; H04L 9/08; H04L 25/02

(52) U.S. Cl. CPC H04W 12/041; H04L 9/0875; H04L 25/0212

(57) ABSTRACT

Methods, systems, and devices for wireless communications are described. In some examples, the method may include a user equipment (UE) transmitting, to a base station, first reference signals. The base station may perform channel estimation using the first reference signals and estimate a value for an uplink channel based on the channel estimation. The base station may generate second reference signals such that a characteristic of a downlink channel seen by the UE is within a target value and transmit the second reference signals to the UE. The UE may estimate a value for the characteristic of the downlink channel and obtain the target value from the estimated value. Both the UE and the base station may generate a secret using the target value and utilize the secret key for physical layer protection.

### CROSS REFERENCE

The present Application is a 371 national stage filing of International PCT Application No. PCT/US2022/049861 by Elshafie et al. entitled “SECRET KEY EXTRACTION FOR PHYSICAL LAYER PROTECTION IN A WIRELESS COMMUNICATIONS SYSTEM,” filed Nov. 14, 2022; and claims priority to Greece patent application No. 20210100849 by Elshafie et al. entitled “SECRET KEY EXTRACTION FOR PHYSICAL LAYER PROTECTION IN A WIRELESS COMMUNICATIONS SYSTEM,” filed Dec. 6, 2021, each of which is assigned to the assignee hereof, and each of which is expressly incorporated by reference in its entirety herein.

### FIELD OF TECHNOLOGY

The following relates to wireless communications, including secret key extraction for physical layer protection in a wireless communications system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some examples, a wireless communications system may utilize cryptographic keys to secure physical layer transmissions. A transmitting device (e.g., a base station) and an intended receiving device (e.g., a user equipment (UE)) may obtain a secret key for physical layer protection using secret key extraction techniques that may rely on channel reciprocity.

### SUMMARY

The described techniques relate to improved methods, systems, devices, and apparatuses that support secret key extraction for physical layer protection in a wireless communications system. Generally, the described techniques provide for a transmitting device (e.g., a base station) and an intended receiving device (e.g., a user equipment (UE)) obtaining a secret key based on a channel characteristic (e.g., doppler spread, doppler delay, or doppler shift). The receiving device may transmit reference signals to the transmitting device and the transmitting device may determine a value for a channel characteristic of an uplink channel between the transmitting device and the receive device using the received reference signals. The transmitting device may generate reference signals such that a channel characteristic of a downlink channel between the transmitting device and the receiving device is within range of a desired value and transmit the reference signals to the receiving device. The receiving device may estimate a value of the characteristic of the downlink channel using the received reference signals and quantize the value of the characteristic of the downlink channel to obtain the desired value. Both the transmitting device and the receiving device may input the desired value into a secret key generator and generate the same secret key. The transmitting may encrypt a transmission using the secret key and the receiving device may decrypt the transmission using the secret key. The methods as described herein may allow the wireless communications system to implement physical layer protection in scenarios where channel reciprocity cannot be assumed.

A method for wireless communication at a UE is described. The method may include transmitting, to a base station, one or more first reference signals, receiving, from the base station in response to the one or more first reference signals, one or more second reference signals corresponding to a target value for a channel characteristic of a downlink channel between the UE and the base station, performing channel estimation on the downlink channel based on the one or more second reference signals, estimating a value of the channel characteristic of the downlink channel based on performing the channel estimation, and generating a set of secret key bits based on the estimated value being within a range of the target value.

An apparatus for wireless communication at a UE is described. The apparatus may include memory, a transceiver, and at least one processor coupled with the memory and the transceiver, the at least one processor configured to cause the apparatus to transmit, to a base station, one or more first reference signals, receive, from the base station in response to the one or more first reference signals, one or more second reference signals corresponding to a target value for a channel characteristic of a downlink channel between the UE and the base station, perform channel estimation on the downlink channel based on the one or more second reference signals, estimate a value of the channel characteristic of the downlink channel based on performing the channel estimation, and generate a set of secret key bits based on the estimated value being within a range of the target value.

Another apparatus for wireless communication at a UE is described. The apparatus may include means for transmitting, to a base station, one or more first reference signals, means for receiving, from the base station in response to the one or more first reference signals, one or more second reference signals corresponding to a target value for a channel characteristic of a downlink channel between the UE and the base station, means for performing channel estimation on the downlink channel based on the one or more second reference signals, means for estimating a value of the channel characteristic of the downlink channel based on performing the channel estimation, and means for generating a set of secret key bits based on the estimated value being within a range of the target value.

A non-transitory computer-readable medium storing code for wireless communication at a UE is described. The code may include instructions executable by a processor to transmit, to a base station, one or more first reference signals, receive, from the base station in response to the one or more first reference signals, one or more second reference signals corresponding to a target value for a channel characteristic of a downlink channel between the UE and the base station, perform channel estimation on the downlink channel based on the one or more second reference signals, estimate a value of the channel characteristic of the downlink channel based on performing the channel estimation, and generate a set of secret key bits based on the estimated value being within a range of the target value.

Some examples of the method, apparatuses, and non-transitory computer-readable medium described herein may further include operations, features, means, or instructions for determining a quantized value of the estimated value of the channel characteristic, where the quantized value includes the target value.

In some examples of the method, apparatuses, and non-transitory computer-readable medium described herein, generating the set of secret key bits may include operations, features, means, or instructions for determining a mapping between the target value and the set of secret key bits.

In some examples of the method, apparatuses, and non-transitory computer-readable medium described herein, generating the set of secret key bits may include operations, features, means, or instructions for inputting the target value into a function to generate a set of output values and converting the set of output values into the set of secret key bits.

Some examples of the method, apparatuses, and non-transitory computer-readable medium described herein may further include operations, features, means, or instructions for receiving, from the base station, signaling that indicates the channel characteristic of the downlink channel, a set of resources for receiving the one or more second reference signals, or both.

In some examples of the method, apparatuses, and non-transitory computer-readable medium described herein, the signaling indicates the set of resources and the method, apparatuses, and non-transitory computer-readable medium may include further operations, features, means, or instructions for receiving, from the base station, an indication of a repetition factor for the one or more second reference signals, the repetition factor identifying a quantity of the one or more second reference signals that may be to be received over the set of resources.

In some examples of the method, apparatuses, and non-transitory computer-readable medium described herein, the set of resources includes a portion of resources of a single slot or multiple slots.

Some examples of the method, apparatuses, and non-transitory computer-readable medium described herein may further include operations, features, means, or instructions for determining a phase difference between transmitting a first signal via a port of the UE and receiving a second signal via the port of the UE, where the port may be used by the UE to transmit the one or more first reference signals and receive the one or more second reference signals and transmitting, to the base station, an indication of the phase difference.

Some examples of the method, apparatuses, and non-transitory computer-readable medium described herein may further include operations, features, means, or instructions for determining a quasi-colocation (QCL) relationship between one or more ports of the UE used to transmit the one or more first reference signals and one or more ports of the UE used to receive the one or more second reference signals, where estimating the value of the channel characteristic may be based on the QCL relationship.

Some examples of the method, apparatuses, and non-transitory computer-readable medium described herein may further include operations, features, means, or instructions for receiving, from the base station, signaling instructing the UE to generate the set of secret key bits based on estimating the value of the channel characteristic when the UE operates according to a frequency division duplexing (FDD) scheme.

Some examples of the method, apparatuses, and non-transitory computer-readable medium described herein may further include operations, features, means, or instructions for receiving, from the base station, control signaling indicating a set of modes for key extraction that includes at least a first mode and a second mode different from the first mode, where the first mode corresponds to the UE generating the set of secret key bits based on estimating the value of the channel characteristic and receiving, from the base station, an indication to perform secret key extraction according to the first mode.

In some examples of the method, apparatuses, and non-transitory computer-readable medium described herein, the channel characteristic may be based on a frequency dispersion or a time dispersion of the one or more second reference signals as received by the UE.

In some examples of the method, apparatuses, and non-transitory computer-readable medium described herein, the channel characteristic includes a delay spread, a doppler shift, or a doppler spread of the one or more second reference signals as received by the UE.

In some examples of the method, apparatuses, and non-transitory computer-readable medium described herein, an uplink channel between the UE and the base station corresponds to a first frequency range and the downlink channel corresponds to a second frequency range, the first frequency range different from the second frequency range.

A method for wireless communication at a base station is described. The method may include receiving one or more first reference signals from a UE, performing channel estimation on an uplink channel between the UE and the base station based on the one or more first reference signals, estimating a value of a channel characteristic of the uplink channel based on performing the channel estimation, generating a set of secret key bits based on a target value of the channel characteristic of the uplink channel, generating, based on the estimated value and the target value, one or more second reference signals such that a channel characteristic of a downlink channel between the base station and the UE is within a range of the target value, and transmitting, to the UE, the one or more second reference signals.

An apparatus for wireless communication at a base station is described. The apparatus may include memory, a transceiver, and at least one processor coupled with the memory and the transceiver, the at least one processor configured to cause the apparatus to receive one or more first reference signals from a UE, perform channel estimation on an uplink channel between the UE and the base station based on the one or more first reference signals, estimate a value of a channel characteristic of the uplink channel based on performing the channel estimation, generate a set of secret key bits based on a target value of the channel characteristic of the uplink channel, generate, based on the estimated value and the target value, one or more second reference signals such that a channel characteristic of a downlink channel between the base station and the UE is within a range of the target value, and transmit, to the UE, the one or more second reference signals.

Another apparatus for wireless communication at a base station is described. The apparatus may include means for receiving one or more first reference signals from a UE, means for performing channel estimation on an uplink channel between the UE and the base station based on the one or more first reference signals, means for estimating a value of a channel characteristic of the uplink channel based on performing the channel estimation, means for generating a set of secret key bits based on a target value of the channel characteristic of the uplink channel, means for generating, based on the estimated value and the target value, one or more second reference signals such that a channel characteristic of a downlink channel between the base station and the UE is within a range of the target value, and means for transmitting, to the UE, the one or more second reference signals.

A non-transitory computer-readable medium storing code for wireless communication at a base station is described. The code may include instructions executable by a processor to receive one or more first reference signals from a UE, perform channel estimation on an uplink channel between the UE and the base station based on the one or more first reference signals, estimate a value of a channel characteristic of the uplink channel based on performing the channel estimation, generate a set of secret key bits based on a target value of the channel characteristic of the uplink channel, generate, based on the estimated value and the target value, one or more second reference signals such that a channel characteristic of a downlink channel between the base station and the UE is within a range of the target value, and transmit, to the UE, the one or more second reference signals.

Some examples of the method, apparatuses, and non-transitory computer-readable medium described herein may further include operations, features, means, or instructions for determining a quantized value of the estimated value of the channel characteristic of the uplink channel, where the quantized value of the estimated value includes the target value of the channel characteristic of the uplink channel.

Some examples of the method, apparatuses, and non-transitory computer-readable medium described herein may further include operations, features, means, or instructions for selecting the target value of the channel characteristic of the uplink channel from a set of values, where the set of values may be stored at the base station and each value of the set of values corresponds to a different set of secret key bits.

In some examples of the method, apparatuses, and non-transitory computer-readable medium described herein, generating the set of secret key bits may include operations, features, means, or instructions for determining a mapping between the target value of the channel characteristic of the uplink channel and the set of secret key bits.

In some examples of the method, apparatuses, and non-transitory computer-readable medium described herein, generating the set of secret key bits may include operations, features, means, or instructions for inputting the target value of the channel characteristic of the uplink channel into a function to generate a set of output values and converting the set of output values into the set of secret key bits.

In some examples of the method, apparatuses, and non-transitory computer-readable medium described herein, generating the one or more second reference signals may include operations, features, means, or instructions for applying a frequency offset to the one or more second reference signals, the frequency offset based on the value of the channel characteristic of the uplink channel and the target value of the channel characteristic of the uplink channel, applying a timing offset to the one or more second reference signals, the timing offset based on the value of the channel characteristic of the uplink channel and the target value of the channel characteristic of the uplink channel, modifying a precoder corresponding to one or more ports associated with resources used to transmit the one or more first reference signals and receive the one or more second reference signals, the modifying based on the value of the channel characteristic of the uplink channel and the target value of the channel characteristic of the uplink channel, and any combination thereof.

In some examples of the method, apparatuses, and non-transitory computer-readable medium described herein, the channel characteristic of the uplink channel includes a delay spread, and estimating the value of the channel characteristic of the uplink channel may include operations, features, means, or instructions for estimating a respective channel impulse response (CIR) and a respective power delay profile (PDP) for each port of at least two ports of the base station, where the at least two ports may be used by the base station to receive the one or more first reference signals.

In some examples of the method, apparatuses, and non-transitory computer-readable medium described herein, generating the one or more second reference signals may include operations, features, means, or instructions for applying a cyclic shift to the one or more second reference signals based on the estimated respective CIR and the estimated respective PDP for each port of the at least two ports.

Some examples of the method, apparatuses, and non-transitory computer-readable medium described herein may further include operations, features, means, or instructions for transmitting, to the UE, signaling that indicates the channel characteristic of the downlink channel, a set of resources for the UE to use to receive the one or more second reference signals, or both.

In some examples of the method, apparatuses, and non-transitory computer-readable medium described herein, the signaling indicates the set of resources and the method, apparatuses, and non-transitory computer-readable medium may include further operations, features, means, or instructions for transmitting, to the UE, an indication of a repetition factor for the one or more second reference signals, the repetition factor identifying a quantity of the or more second reference signals to be received by the UE over the set of resources.

In some examples of the method, apparatuses, and non-transitory computer-readable medium described herein, the set of resources includes a portion of resources of a single slot or multiple slots.

Some examples of the method, apparatuses, and non-transitory computer-readable medium described herein may further include operations, features, means, or instructions for receiving, from the UE, an indication of a phase difference between transmitting a first signal via a port of the UE and receiving a second signal via the port of the UE, where the port may be used by the UE to transmit the one or more first reference signals and receive the one or more second reference signals, and where generating the one or more second reference signals may be based on the phase difference.

Some examples of the method, apparatuses, and non-transitory computer-readable medium described herein may further include operations, features, means, or instructions for determining a QCL between one or more ports used to receive the one or more first reference signals and one or more ports used to transmit the one or more second reference signals, where estimating the value of the channel characteristic of the uplink channel may be based on the QCL relationship.

Some examples of the method, apparatuses, and non-transitory computer-readable medium described herein may further include operations, features, means, or instructions for transmitting, to the UE, signaling instructing the UE to obtain the set of secret key bits based on estimating a value of the channel characteristic of the downlink channel when the UE operates according to an FDD scheme.

Some examples of the method, apparatuses, and non-transitory computer-readable medium described herein may further include operations, features, means, or instructions for transmitting, to the UE, control signaling indicating a set of modes for key extraction that includes at least a first mode and a second mode different from the first mode, where the first mode corresponds to the UE generating the set of secret key bits based on estimating a value of the channel characteristic of the downlink channel and transmitting, to the UE, an indication to perform secret key extraction according to the first mode.

In some examples of the method, apparatuses, and non-transitory computer-readable medium described herein, the channel characteristic of the uplink channel may be based on a frequency dispersion or a time dispersion of the one or more first reference signals as received by the base station.

In some examples of the method, apparatuses, and non-transitory computer-readable medium described herein, the channel characteristic of the uplink channel includes a delay spread, a doppler shift, or a doppler spread of the one or more first reference signals as received by the base station.

In some examples of the method, apparatuses, and non-transitory computer-readable medium described herein, the uplink channel corresponds to a first frequency range and the downlink channel corresponds to a second frequency range, the first frequency range different from the second frequency range.

### BRIEF DESCRIPTION OF THE DRAWINGS

FIGS. 1 and 2 illustrate examples of a wireless communications system that supports secret key extraction for physical layer protection in a wireless communications system in accordance with aspects of the present disclosure.

FIG. 3 illustrates an example of a reference signal generation scheme that supports secret key extraction for physical layer protection in a wireless communications system in accordance with aspects of the present disclosure.

FIG. 4 illustrates an example of a process flow that supports secret key extraction for physical layer protection in a wireless communications system in accordance with aspects of the present disclosure.

FIGS. 5 and 6 show block diagrams of devices that support secret key extraction for physical layer protection in a wireless communications system in accordance with aspects of the present disclosure.

FIG. 7 shows a block diagram of a communications manager that supports secret key extraction for physical layer protection in a wireless communications system in accordance with aspects of the present disclosure.

FIG. 8 shows a diagram of a system including a device that supports secret key extraction for physical layer protection in a wireless communications system in accordance with aspects of the present disclosure.

FIGS. 9 and 10 show block diagrams of devices that support secret key extraction for physical layer protection in a wireless communications system in accordance with aspects of the present disclosure.

FIG. 11 shows a block diagram of a communications manager that supports secret key extraction for physical layer protection in a wireless communications system in accordance with aspects of the present disclosure.

FIG. 12 shows a diagram of a system including a device that supports secret key extraction for physical layer protection in a wireless communications system in accordance with aspects of the present disclosure.

FIGS. 13 through 18 show flowcharts illustrating methods that support secret key extraction for physical layer protection in a wireless communications system in accordance with aspects of the present disclosure.

### DETAILED DESCRIPTION

A wireless communications system may support the use of cryptographic keys to protect transmissions. In symmetric key cryptography, a receiving device (e.g., a user equipment (UE)) and a transmitting device (e.g., a base station) may obtain the same secret key. The transmitting device may encrypt a transmission with the secret key and the intended receiving device may decrypt the transmission using the secret key. To ensure that a malicious device does not obtain the secret key, the transmitting device and the intended receiving device may obtain the secret key using type-A secret key extraction or type-B secret key extraction. In type-A secret key extraction, the transmitting device and the receiving device may obtain the secret key using a metric obtained via channel estimation. In type-B secret key extraction, the transmitting device may estimate the channel and set a received signal at the receiving device to some value. The transmitting device and the receiving device may use the value to obtain the secret key. Although the two key extraction techniques discussed above may provide adequate protection from a malicious device, they may rely on channel reciprocity. Channel reciprocity is present in time division duplexing (TDD) systems, but may not be present in frequency division duplexing (FDD) systems. As such, methods for data protection for a wireless communications system operating according to FDD may be beneficial.

Using the methods as described herein, the transmitting device and the receiving device may obtain a secret key using type-C secret key extraction or using characteristics of a channel. As one example, the receiving device may transmit one or more sounding reference signals (SRSs) to the transmitting device and the transmitting device may utilize the SRSs to estimate the channel. From the estimated channel, the transmitting device may estimate a channel characteristic. For example, the transmitting device may estimate a delay spread, a doppler shift, and a doppler spread of the channel. The transmitting device may then manipulate reference signals (e.g., during precoding, by applying a timing offset, etc.) such that a channel characteristic of the signal received at the receiving device is at a desired value. The receiving device may receive the reference signals from the transmitting device and estimate a value of the channel characteristic, where the estimated value is within range of the desired value set by the transmitting device.

Both the transmitting device and the receiving device may utilize the desired value to generate the same set of secret key bits. In some examples, prior to performing type-C secret key extraction, the transmitting device may inform the receiving device of the parameters associated with type-C secret key extraction (e.g., a set of resources for transmitting/receiving reference signals, one or more channel characteristics to measure, etc.) Additionally, the receiving device may be configured with multiple secret key extraction techniques (e.g., type-A, type-B, and type-C). The transmitting device may instruct the receiving device on which secret key extraction technique to use or the receiving device may select a secret key extraction technique to use based on a duplexing mode that is active. For example, the receiving device and the transmitting device may select to perform type-C secret key extraction when FDD is active. Using the methods as described herein may allow a wireless communication system to protect physical layer transmissions in scenarios where channel reciprocity cannot be assumed (e.g., when FDD is active).

Aspects of the disclosure are initially described in the context of wireless communications systems. Additional aspects of the disclosure are described in the context of a reference signal generation scheme and a process flow. Aspects of the disclosure are further illustrated by and described with reference to apparatus diagrams, system diagrams, and flowcharts that relate to secret key extraction for physical layer protection in a wireless communications system.

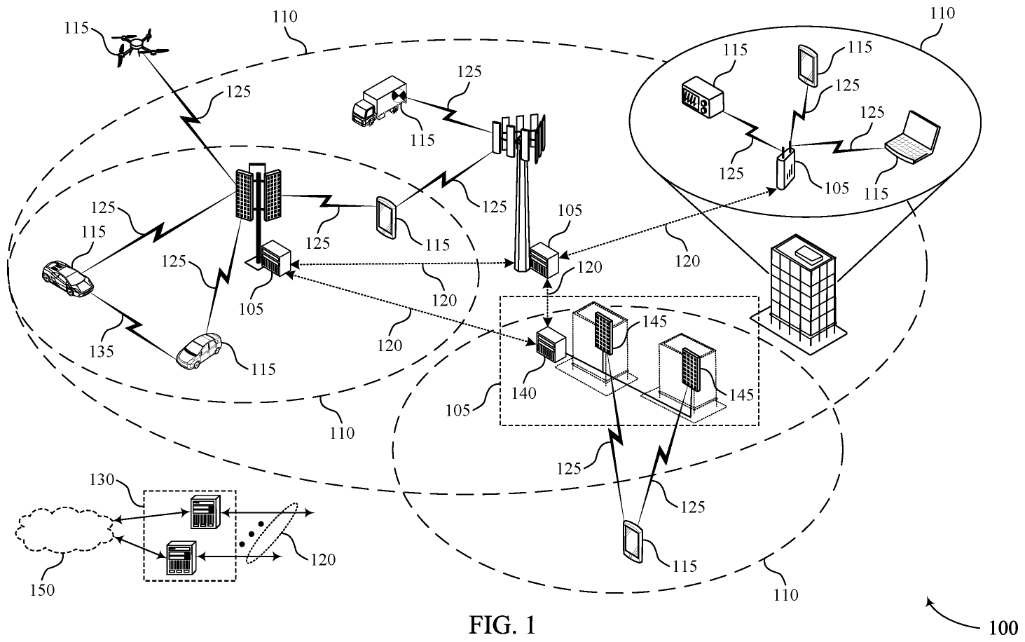

FIG. 1 illustrates an example of a wireless communications system 100 that supports secret key extraction for physical layer protection in a wireless communications system in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1: M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In some examples, a base station 105 and a UE 115 (e.g., an intended receiving device) may obtain a secret key based on a channel characteristic (e.g., doppler spread, doppler delay, or doppler shift). The UE 115 may transmit reference signals to the base station 105 and the base station 105 may determine a value for a channel characteristic of an uplink channel between the base station 105 and the UE 115 using the received reference signals. The base station 105 may generate reference signals such that a channel characteristic of a downlink channel between the base station 105 and the UE 115 is within range of a desired value and transmit the reference signals to the UE 115. The UE 115 may estimate a value of the characteristic of the downlink channel using the received reference signals and quantize the value of the characteristic of the downlink channel to obtain the desired value. Both the base station 105 and the UE 115 may input the desired value into a secret key generator and generate the same secret key. The base station 105 may encrypt a transmission using the secret key and the UE 115 device may decrypt the transmission using the secret key. The methods as described herein may allow the wireless communications system 100 to implement physical layer protection in scenarios where channel reciprocity cannot be assumed.

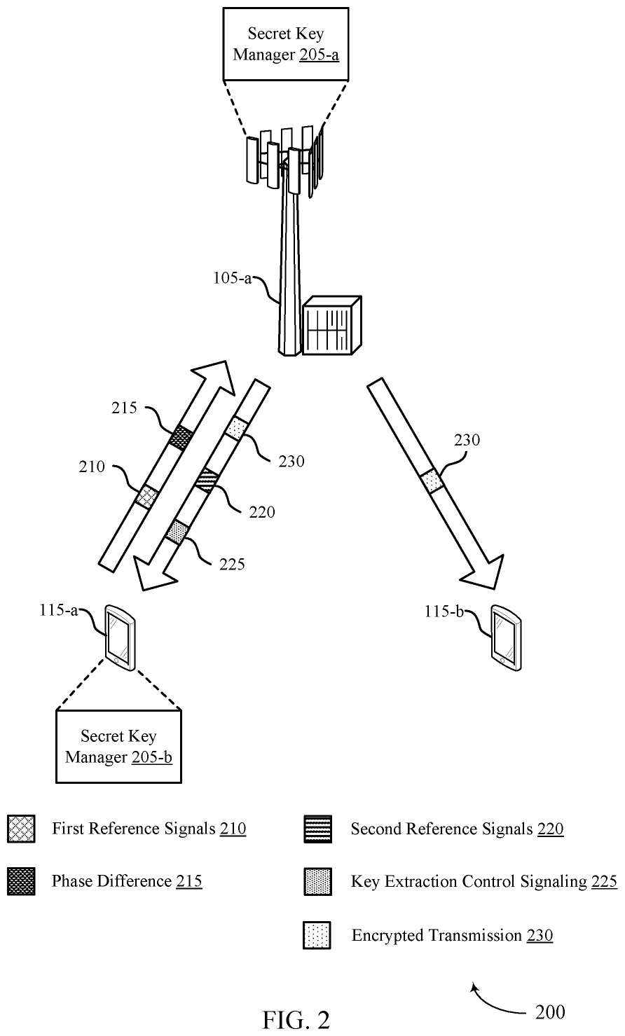

FIG. 2 illustrates an example of a wireless communications system 200 that supports secret key extraction for physical layer protection in a wireless communications system in accordance with aspects of the present disclosure. In some examples, the wireless communications system 200 may implement aspects of a wireless communications system 100. For example, the wireless communications system 200 may include a base station 105-a, a UE 115-a, and a UE 115-b which may be examples of a base station 105 and UEs 115 as described with reference to FIG. 1.

In some examples, the wireless communications system 200 may implement secret keys (e.g., cryptographic keys). A secret key may be described as a piece of information (e.g., a string of bits) that is used to alter data such that only devices that have access to the secret key or a key associated with the secret key may decipher the data. Secret key algorithms may be symmetrical or asymmetrical. When utilizing asymmetrical key algorithms, a transmitting device (e.g., the base station 105-a) may encrypt data using a public key (e.g., a key that may be available to any device) and a receiving device (e.g., the UE 115-a or the UE 115-b) may decrypt the data using a private key (e.g., a key that may only be known to the intended receiving device and the transmitting device). When utilizing symmetric key algorithms, a transmitting device may use a secret key to encrypt the data and a receiving device may use the same secret key to decrypt the data.

The implementation of secret keys may allow a transmitting device to protect data transmissions from being decoded by one or more malicious devices. A malicious device may be any wireless device within proximity of an intended receiving device. As one example, the base station 105-a may be an example of the transmitting device and transmit a data transmission to the UE 115-a, where the UE 115-a is the intended receiving device. If the data transmission is not encrypted (e.g., using cryptographic keys), a malicious device (e.g., the UE 115-b) may also receive the data transmission and easily decode the data transmission. If the base station 105-a encrypts the data using a secret key only known to the base station 105-a and the UE 115-a, the malicious device may be unable to decode the data transmission because, unlike the base station 105-a and the UE 115-a, it may not have access to the secret key used to encrypt the transmission.

The transmitting device and the intended receiving device may obtain the secret key using one of many secret key extraction techniques. To provide physical layer security (e.g., protect transmissions over a physical uplink control channel (PUCCH), a physical downlink shared channel (PDSCH), or a physical uplink shared channel (PUSCH)), the transmitting device and the receiving device may extract the secret key using information related to a channel. A channel may be described as a communication medium that can be used to send data from one wireless device to another wireless device. In wireless communication, a channel may refer to a band of frequency. The channel may be effected by many factors (e.g., location of a receiving device relative to a transmitting device). As such, a channel between the UE 115-a and the base station 105-a may be different from a channel between the UE 115-b and the base station 105-a.

In one example, the receiving device and transmitting device may extract the secret key from channel randomness. This type of secret key extraction technique may be known as type-A secret key extraction. When utilizing type-A secret key extraction, the transmitting device and the intended receiving device may exchange reference signals with one another and estimate the channel between the transmitting device and the intended receiving device. After estimating the channel, the transmitting device and the receiving device may obtain a metric based on the channel estimation (e.g., channel power, reference signal received power (RSRP), signal-to-interference plus noise (SINR), or phase information) and quantize the value of the metric (e.g., compare value to a set of bins and set the value to a value of the bin that it is the closest to). Using this quantized value, the transmitting device and the receiving device may determine a secret key (e.g., based on a mapping between the quantized value and the secret key). The transmitting device and the intended receiving device may then use this secret key to secure transmissions or secure some fields within a physical channel.

In another example, the receiving device and the transmitting device may extract the secret key from channel estimation results. This type of secret key extraction technique may be known as type-B secret key extraction. When utilizing type-B secret key extraction, the receiving device may transmit one or more reference signals to the transmitting device and the transmitting device may estimate the channel using the one or more reference signals. The transmitting device may then generate one or more reference signals such that the channel seen by the receiving device is equal to some parameter (e.g., the estimated channel multiplied by some precoder). The receiving device and the transmitting device may apply a function to the parameter (e.g., a function previously agreed upon by the transmitting device and the receiving device) and input the value of this function into a key derivation function to determine the secret key. The transmitting device and the intended receiving device may then use this secret key to secure transmissions or secure some fields within a physical channel. Unlike type-A secret key extraction, type-B secret key extraction may allow the transmitting device to set the secret key at the receiving device to a desired value which may allow for the implementation of common secret keys for group common transmissions (e.g., group common DCI).

Both type-A secret key extraction and type-B secret key extraction rely on channel reciprocity. That is, the channel seen by the transmitting device is the reciprocal of the channel seen by the receiving device. Channel reciprocity may be assumed in TDD systems, where the frequency band for an uplink channel and the frequency band for a downlink channel are the same, but channel reciprocity may not be assumed in FDD systems, where the frequency band for the uplink channel is different from the frequency band for the downlink channel. As such, the wireless communications system 200 may be unable to implement type-A secret key extraction and type-B secret key extraction if FDD is supported resulting in a loss of physical layer protection for FDD systems.

As described herein, a transmitting device and receiving device may extract the secret key using channel characteristics determined via channel estimation. This secret key extraction technique may be known as type-C secret key extraction. In one example, the base station 105-a may be the transmitting device, the UE 115-a may be the intended receiving device, and UE 115-b may be the malicious device. To support the type-C secret key extraction, the UE 115-a may implement a secret key manager 205-a and the base station 105-a may implement a secret key manager 205-b. The UE 115-a may transmit one or more first reference signals 210 (e.g., sounding reference signals (SRSs)) to the base station 105-a. Using the one or more first reference signals 210, the base station 105-a may estimate the uplink channel between the UE 115-a and the base station 105-a and estimate a first value of one or more characteristics of the uplink channel from the estimated channel. For example, the base station 105-a may estimate a value for a doppler shift of the channel, a doppler spread of the channel, or a delay spread of the channel. Due to multipath propagation, multiple copies of a signal (e.g., first reference signal 210) may arrive at a receiver with different delays. This timing distribution of the received signal may be captured by the delay spread. On the other hand, doppler shift and doppler spread may refer to a frequency distribution of the received signal due to multipath propagation of the signal as well as the motion of a transmitter.

The base station 105-a may utilize the estimated first value of the one or more channel characteristics to generate one or more second reference signals 220 (e.g., channel state information reference signal (CSI-RS) or tracking reference signal (TRS)) to be sent to the UE 115-a. The base station 105-a may generate (or manipulate) the one or more second reference signals 220 such that a value of the one or more channel characteristics estimated by the UE 115-a is within range of a desired value (e.g., a second value selected by the base station 105-a). In one example, the base station 105-a may select the desired value to be the quantized version of the estimated value. In another example, a set of candidate values for the one or more channel characteristics may be stored at the base station 105-a and the base station 105-a may select a candidate value from the set to be the desired value. In some examples, the base station 105-a may select the desired value based on a type of transmission that is to be encrypted or based on the intended receiving device (e.g., identifier of the UE 115-a). For example, the base station 105-a may select different desired values for different UEs 115 if the transmission to be encrypted is specific to the UE 115 (e.g., PDSCH transmission or UE specific DCI). Alternatively, the base station 105-a may select the same desired value for a group of UEs 115 if the transmission to be encrypted is intended for the group (e.g., group specific DCI). To set the one or more channel characteristics seen by the UE 115-a to the desired value, the base station 105-a may use the knowledge of the estimated value to manipulate a precoder used to generate the one or more second reference signals 220 or apply a frequency offset or a timing offset to the one or more second reference signals 220.

The UE 115-a may receive the one or more second reference signals 220 and estimate a downlink channel between the UE 115-a and the base station 105-a. Based on the estimated channel, the UE 115-a may estimate a value for the one or more characteristics of the downlink channel. The estimated value may be within a range of the desired value. In some examples, the UE 115-a may quantize the estimated value and the quantized version of the estimated value may be equal to the desired value. The base station 105-a and the UE 115-a may then use the desired value to determine the secret key using their respective secret key managers 205. In one example, the base station 105-a and the UE 115-a may input the desired value into a cryptographic-secure pseudorandom number generator (e.g., CSPRNG) to generate a sequence of random numbers and convert the sequence of random numbers into a set of secure bits that represents the secret key. In another example, the secret key may be obtained by mapping the desired value using a mapping function (e.g., a hash function) prior to being input into the CSPRNG. In another example, the UE 115-a and the base station 105-b may determine a mapping between the desired value and a set of secret key bits and determine the secret key bits based on the mapping. The UE 115-a and the base station 105-a may store a table including mappings between quantized channel characteristic values (e.g., including the desired value) and sets of secret key bits. In some examples, the base station 105-a may transmit signaling to the UE 115-a indicating the table.

In some examples, the base station 105-a and the UE 115-a may undergo a key refinement procedure to ensure that they obtained the same secret key. During the key refinement procedure, the base station 105-a may exclusive or (XOR) its obtained set of secret key bits with a set of bits and the UE 115-a may XOR its obtained set of secret key bits with the set of bits. The UE 115-a and the base station 105-a may then exchange the output of their XOR functions. If the outputs match, the secret key may be valid. If the outputs do not match, the secret key is may not be valid. In the case that the secret key is not valid, the base station 105-a and the UE 115-a may repeat the secret key extraction procedure until the secret key is deemed valid.

Once the UE 115-a and the base station 105-a obtain the secret key. The UE 115-a and the base station 105-a may utilize the secret key to protection physical layer transmissions. As one example, the base station 105-a may encrypt a transmission using the secret key and transmit the encrypted transmission 230 to the UE 115-a. The UE 115-a may receive the encrypted transmission 230 and decrypt the encrypted transmission 230 using the secret key. Because UE 115-b may be in proximity to UE 115-a, the UE 115-b may also receive the encrypted transmission 230. Because the downlink channel between the UE 115-a and the base station 105-a is different from the downlink channel between UE 115-b and the base station 105-a, the UE 115-b may be unable to obtain the secret key using type-C secret key extraction and as such, may be unable to decode the encrypted transmission 230. The one or more characteristics of the channel used by the base station 105-a and the UE 115-a to obtain the secret key may not depend on the frequency band of the channel, but may rather depend on the multipath propagation of a signal or a location or speed of the receiving device (e.g., the UE 115-a). As such, type-C secret key extraction may be implemented in both TDD systems and in FDD systems.

In some examples, prior to performing secret key extraction (e.g., type A, type B, or type C secret key extraction), the UE 115-a may receive key extraction control signaling 225 from the base station 105-a. In one example, the key extraction control signaling 225 may indication parameters used for type-C secret key extraction. For example, the key extraction control signaling 225 may indicate which characteristics of the channel to analyze during type-C secret key extraction (e.g., one or more of a doppler spread, a doppler shift, or a delay spread of the channel). Additionally or alternatively, the key extraction control signaling 225 may indicate a set of resources (e.g., frequency resources) to use for type-C secret key extraction. For example, the key extraction control signaling 225 may include an indication of a set of resources for receiving the one or more second reference signals 220. Additionally, the key extraction control signaling 225 may include a repetition factor associated with the one or more second reference signals 220. The repetition factor may indicate a number of times that second reference signals 220 may be repeated over the set of resources. The second reference signals 220 may be repeated within the same slot (e.g., intra-slot repetition) or different slots (e.g., inter-slot repetition).

In another example, the key extraction control signaling 225 may indicate which key extraction technique the base station 105-a and the UE 115-a are going to use. For example, the base station 105-a may configure the UE 115-a to use either type-A secret key extraction, type-B secret key extraction, or type-C secret key extraction. In some examples, the UE 115-a may determine which secret key technique to use based on an active duplexing scheme. In such example, the UE 115-a may be configured with a set of secret key extraction techniques (e.g., type-A secret key extraction, type-B secret key extraction, or type-C secret key extraction). If FDD operation is active, the UE 115-a may select type-C secret key extraction. If TDD operation is active, the UE 115-a may select from one of type-A secret key extraction, type-B secret key extraction, or type-C secret key extraction.

In some examples, to ensure that a value of the one or more characteristics of the uplink channel and a value of the one or more characteristics of the downlink channel are within range of one another or such that the base station 105-a may accurately set the one or more characteristics of the downlink channel to the desired value, the UE 115-a and the base station 105-a may determine a quasi-colocation (QCL) relationship between antenna ports corresponding to the one or more first reference signals 210 and antenna ports corresponding to the one or more second reference signals 220. Based on this QCL relationship, the UE 115-a may use the same antenna ports to transmit the one or more first reference signals 210 as to receive the one or more second reference signals 220. In some examples, even if the same antenna ports are used, a phase difference may be present between receiving the one or more first reference signals 210 and the one or more second reference signals 220. In such cases, the UE 115-a may report a phase difference 215 between transmitting a signal and receiving a signal from the same set of antenna ports. In some examples, the base station 105-a may utilize the phase difference 215 when generating (or manipulating) the one or more second reference signals 220. Using the techniques as described herein may allow the wireless communications system 200 to protect physical layer transmissions independent of the duplexing mode supported by the wireless communications system 200.

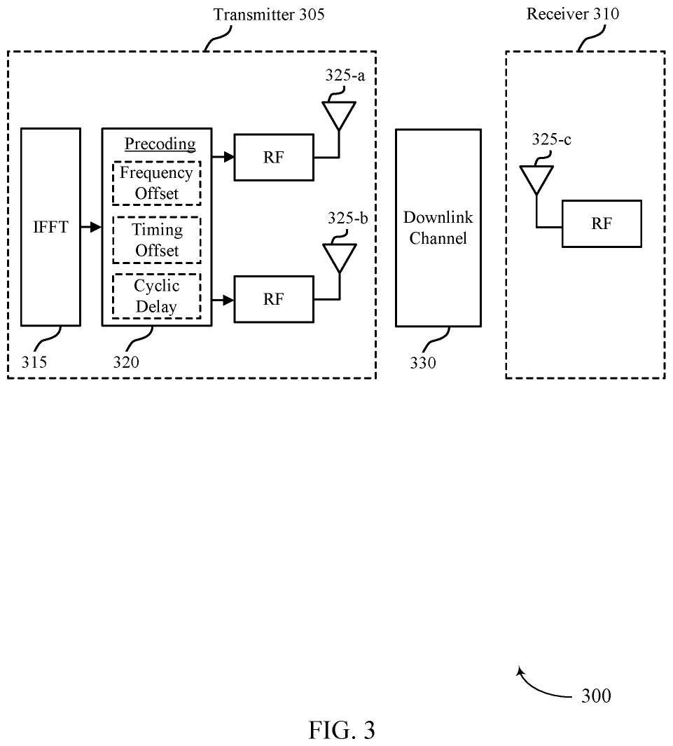

FIG. 3 illustrates an example of a reference signal generation scheme 300 that supports secret key extraction for physical layer protection in a wireless communications system in accordance with aspects of the present disclosure. In some examples, the reference signal generation scheme 300 may implement aspects of a wireless communications system 100 and a wireless communications system 200. For example, the reference signal generation scheme 300 may include a transmitter 305 which may be an example of a base station 105 as described in FIGS. 1 and 2 and a receiver 310 which may be an example of a UE 115 as described in FIGS. 1 and 2.

As described in FIG. 2, the transmitter 305 (e.g., a base station) may manipulate a reference signal that is to be sent to the receiver 310 such that a channel characteristic of a downlink channel 330 (e.g., delay spread, doppler spread, or doppler shift) seen by the receiver 310 is at a target value (e.g., desired value determined by the transmitter 305). In some examples, the transmitter 305 may manipulate the reference signal during precoding 320. Precoding 320 may take place after applying Inverse Fast Fourier Transform (IFFT) 315 (e.g., transforming the reference signal from frequency domain to time domain) and before adding a cyclic prefix (CP) to the reference signal. Precoding 320 may refer to the process in which incoming data is distributed to different antenna ports. In some examples, using precoding 320, the transmitter 305 may control the amplitude and phases of a signal transmitted from antennas 325.

The transmitter 305 may estimate a value of the channel characteristic of an uplink channel between the transmitter 305 and the receiver 310 and use the knowledge of the estimated value to manipulate the reference signal. In one example, the base station 105-b may apply a different precoder (e.g., different precoding matrix) during precoding 320 to manipulate the reference signal in such a way that the characteristics of the downlink channel 330 seen by the receiver 310 is at the target value. In another example, the transmitter 305 may apply a frequency offset or a timing offset to the reference signal during precoding 320 to manipulate the reference signal in such way as that the characteristic of the downlink channel 330 seen by the receiver 310 is at the target value.

In one example, the transmitter 305 may leverage cyclic delay diversity (CDD) to set the delay spread of the downlink channel to a target value. First, the transmitter 305 may estimate channel impulse response (CIR) or power delay profile (PDP) over the antenna 325-a and CIR or PDP over the antennas 325-b. CIR and PDP may give the transmitter 305 an indication of what the delay spread of the downlink channel 330 will be. As such, changing the CIR or the PDP over one of the antennas 325 may cause the delay spread of the downlink channel 330 to change. To change the CIR and the PDP over one of the antennas 325, the base station 105-b may apply CDD to a copy of the reference signal. That is, the base station 105-b may transmit an original copy of the reference signal via the antenna 325-a and a cyclic shifted version of the original copy of the reference signal via the antenna 325-b. An amount that the reference signal is shifted may be dependent on the target value of the delay spread and the estimated values of the CIR or PDP. The receiver 310 may receive the original copy of reference signal and the cyclic version of the original copy of the reference signal via an antenna 325-c and measure the delay spread based on channel estimation performed on the combination of the two copies.

In some examples, the receiver 310 may quantize the measured value of the characteristic of the downlink channel 330 (e.g., quantize the measured value of the delay spread) and use the quantized value of the characteristic to generate a set of secret key bits. In some examples, the quantized value may be equal to the target value set by the transmitter 305. In such case, the transmitter 305 and the receiver 310 may generate the same set of secret key bits. As such, the transmitter 305 may encrypt transmissions to the receiver 310 using the set of secret key bits and the receiver 310 may decrypt the transmissions from the transmitter 305 using the set of secret bits. The techniques as described herein may provide protection for physical later system even in scenarios where channel reciprocity between the transmitter 305 and the receiver 310. is not present.

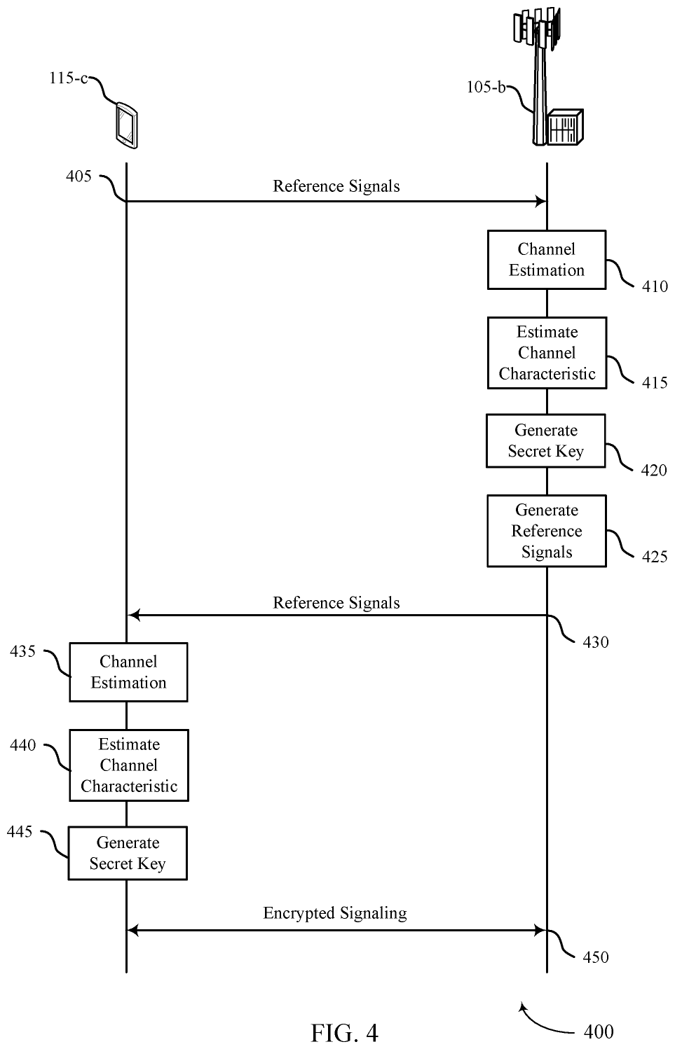

FIG. 4 illustrates an example of a process flow 400 that supports secret key extraction for physical layer protection in a wireless communications system in accordance with aspects of the present disclosure. In some examples, the process flow 400 may implement aspects of a wireless communications system 100, a wireless communications system 200, and a reference signal generation scheme 300. For example, the process flow 400 may include a base station 105-b and a UE 115-c which may be examples of a base station 105 and a UE 115 as described with reference to FIGS. 1 and 2. Alternative examples of the following may be implemented, where some steps are performed in a different order then described or are not performed at all. In some cases, steps may include additional features not mentioned below, or further steps may be added.

In some examples, prior to performing secret key extraction as described herein, the base station 105-b may transmit control signaling to the UE 115-c indicating a set of modes for secret key extraction. The set of modes may include at least a first mode and a second mode different from the first mode. As one example, the set of modes may include type-A secret key extraction, type-B secret key extraction and type-C secret key extraction as described in further detail with reference to FIG. 2.

In some examples, the UE 115-c may select which mode to use based on a type of duplexing scheme supported by the UE 115-c. For example, if FDD is active, the UE 115-c may select type-C secret key extraction. Alternatively, the base station 105-b may transmit signaling to the UE 115-c indicating which mode of secret key extraction to use (e.g., either type-A, type-B, or type-C). In some examples, if type-C secret key extraction is supported at the UE 115-c, the base station 105-b may transmit signaling to the UE 115-c indicating one or more parameters associated with type-C secret key extraction. For example, the base station 105-b may indicate one or more characteristics of a channel (e.g., delay spread, doppler spread, or doppler shift) to be measured by the UE 115-c during type-C secret key extraction. Additionally, the base station 105-b may transmit signaling indicating a set of resources for type-C secret key extraction (e.g., resources over which to receive or transmit reference signals) and a repetition factor for a reference signal to be received from the base station 105-b. The repetition factor may identify a quantity of times a reference signal is repeated in at least a portion of the set of resources. The reference signal may be repeated in the same slot (e.g., intra-slot repetition) or in different slots (e.g., inter-slot repetition).

At 405, the UE 115-c may determine to use type-C extraction and transmit one or more first reference signals to the base station 105-b. In some examples, the one or more first reference signals may include SRSs.

At 410, the base station 105-b may perform channel estimation on an uplink channel between the UE 115-c and the base station 105-b based on the received one or more first reference signals.

At 415, the base station 105-b may estimate a first value for a channel characteristic of the uplink channel based on performing the channel estimation. For example, the base station 105-b may estimate a doppler spread, a doppler shift, or a delay spread of the uplink channel. In some examples, the base station 105-b may estimate the first value of the channel characteristic of the uplink channel using phase information obtained from the UE 115-c. The phase information may indicate a phase difference between a signal that is transmitted by the UE 115-c using a set of antenna ports and a signal received by the UE 115-c using the set of antenna ports. The set of antenna ports may correspond to antenna ports used by the UE 115-c exchange reference signals (e.g., the one or more first reference signals) with the base station 105-b.

At 420, the base station 105-b may generate a set of secret key bits based on a target value of the channel characteristic of the uplink channel. In one example, the target value may be a quantized version of the estimated first value. In another example, the target value may be a value selected by the base station 105-b that is different from the quantized value of the estimated first value. In such example, the base station 105-b may select the target value from a set of values (e.g., set of values stored at the base station 105-b).

Once the base station 105-b determines the target value, the base station 105-b may generate the set of secret key bits. In one example, the base station 105-b may input the target value of the channel characteristic of the uplink channel into a function to generate a set of output values and convert the set of output values into the set of secret key bits. In another example, the base station 105-b may determine a mapping between the target value of the channel characteristic of the uplink channel and the set of secret key bits and generate the set of secret key bits based on the mapping.

At 425, the base station 105-b may generate one or more second reference signals such that a channel characteristic of a downlink channel seen by the UE 115-c is within range of the target value. In some examples, the base station 105-b may apply a frequency offset or timing offset or modify a precoder during the precoding step of generating the one or more second reference signals. The base station 105-b may determine the type of precoder to use or the amount of frequency offset or timing offset to apply based on the target value of the channel characteristic of the uplink channel and the estimated first value of the channel characteristic of the uplink channel. The one or more second reference signals may be CSI-RSs or TRSs.

At 430, the base station 105-b may transmit the one or more second reference signals to the UE 115-c. In some examples, the UE 115-c may use the same set of antenna ports used to the transmit the one or more first reference signals to the base station 105-b to receive the one or more second reference signals from the base station 105-b. That is, the UE 115-c may determine a QCL relationship between the antenna ports used to transmit the one or more first reference signals and the antenna ports used to receive the one or more second reference signals (e.g., QCL relationship between CSI-RS ports and SRS ports).

At 435, the UE 115-c may perform channel estimation on a downlink channel between the UE 115-c and the base station 105-b based on the received one or more second reference signals.

At 440, UE 115-c may estimate a second value for the channel characteristic of the downlink channel based on performing the channel estimation. For example, the UE 115-c may estimate a doppler spread, a doppler shift, or a delay spread of the downlink channel.

At 445, the UE 115-c may generate a set of secret key bits. In some examples, the UE 115-c may quantize the estimated second value of the channel characteristic of the downlink channel and generate the secret key bits based on the quantized version of the estimated second value. The quantized value of the estimated second value may be equal to the target value (e.g., determined by the base station 105-b) and as such, the UE 115-c may generate the same set of secret bits that were generated by the base station 105-b at 420.

At 450, the UE 115-c may receive encrypted signaling from the base station 105-b, transmit encrypted signaling to the base station 105-b, or both. The UE 115-c or the base station 105-b may encrypt the encrypted signaling using the set of secret bits, and the UE 115-c or the base station 105-b may decrypt the encrypted signaling using the set of secret bits.

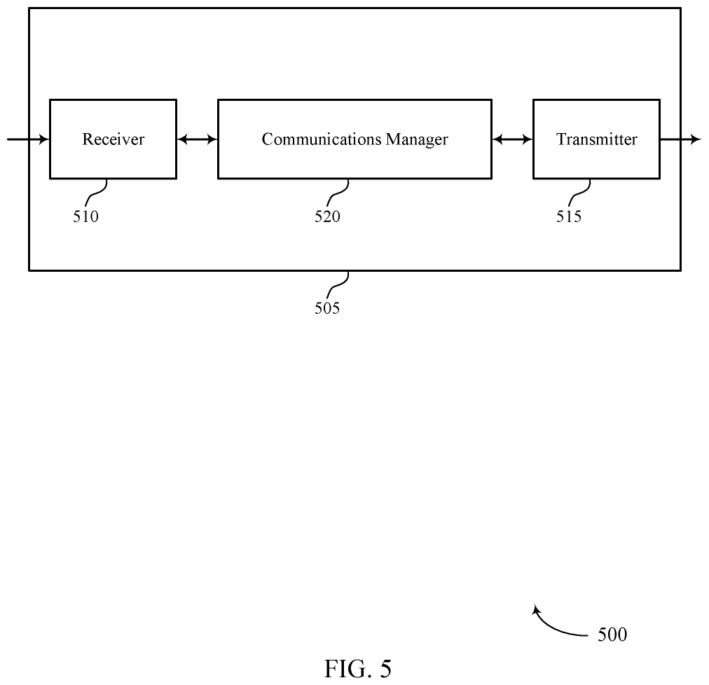

FIG. 5 shows a block diagram 500 of a device 505 that supports secret key extraction for physical layer protection in a wireless communications system in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to secret key extraction for physical layer protection in a wireless communications system). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to secret key extraction for physical layer protection in a wireless communications system). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of secret key extraction for physical layer protection in a wireless communications system as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for transmitting, to a base station, one or more first reference signals. The communications manager 520 may be configured as or otherwise support a means for receiving, from the base station in response to the one or more first reference signals, one or more second reference signals corresponding to a target value for a channel characteristic of a downlink channel between the UE and the base station. The communications manager 520 may be configured as or otherwise support a means for performing channel estimation on the downlink channel based on the one or more second reference signals. The communications manager 520 may be configured as or otherwise support a means for estimating a value of the channel characteristic of the downlink channel based on performing the channel estimation. The communications manager 520 may be configured as or otherwise support a means for generating a set of secret key bits based on the estimated value being within a range of the target value.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing and more efficient utilization of communication resources. The techniques as described herein may allow a transmitting device to set a key at a receiving device (e.g., a device 505) with a value that the transmitting device desires. This may allow the transmitting device to send group common keys which may be used for group common transmissions. Using traditional techniques, the transmitting device may be unable to set common keys and as such, may be unable to protect group common transmissions or alternatively, to protect information included in the group transmission, the transmitting device may set receiver-specific keys and send the information in receiver-specific transmission which may waste valuable resources and increase processing power at the device 505.

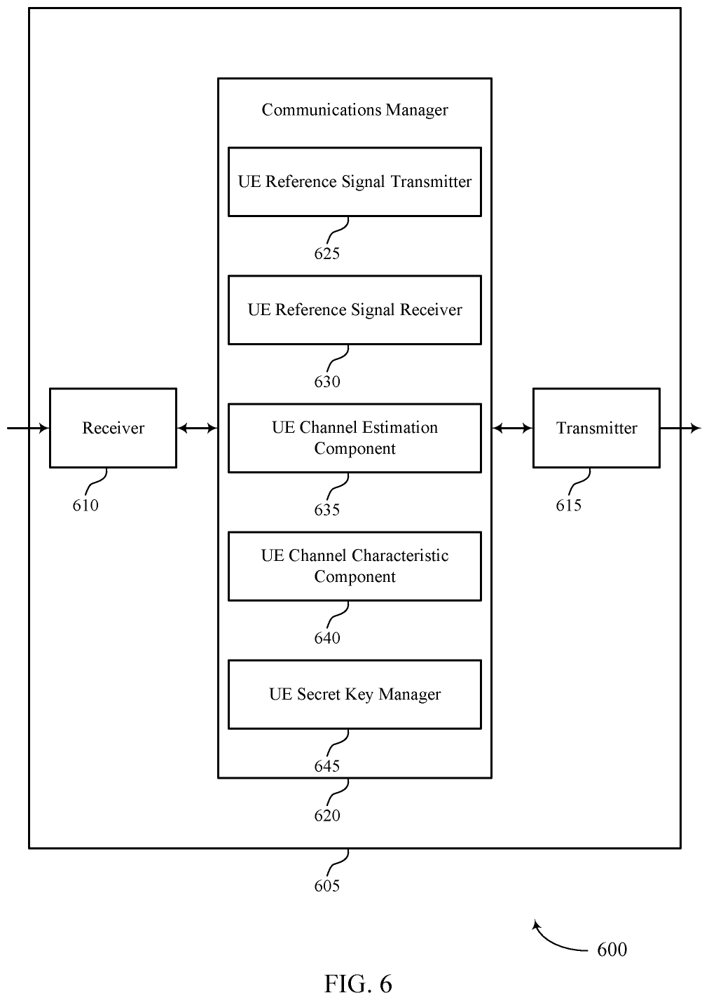

FIG. 6 shows a block diagram 600 of a device 605 that supports secret key extraction for physical layer protection in a wireless communications system in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to secret key extraction for physical layer protection in a wireless communications system). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to secret key extraction for physical layer protection in a wireless communications system). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of secret key extraction for physical layer protection in a wireless communications system as described herein. For example, the communications manager 620 may include a UE reference signal transmitter 625, a UE reference signal receiver 630, a UE channel estimation component 635, a UE channel characteristic component 640, a UE secret key manager 645, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The UE reference signal transmitter 625 may be configured as or otherwise support a means for transmitting, to a base station, one or more first reference signals. The UE reference signal receiver 630 may be configured as or otherwise support a means for receiving, from the base station in response to the one or more first reference signals, one or more second reference signals corresponding to a target value for a channel characteristic of a downlink channel between the UE and the base station. The UE channel estimation component 635 may be configured as or otherwise support a means for performing channel estimation on the downlink channel based on the one or more second reference signals. The UE channel characteristic component 640 may be configured as or otherwise support a means for estimating a value of the channel characteristic of the downlink channel based on performing the channel estimation. The UE secret key manager 645 may be configured as or otherwise support a means for generating a set of secret key bits based on the estimated value being within a range of the target value.

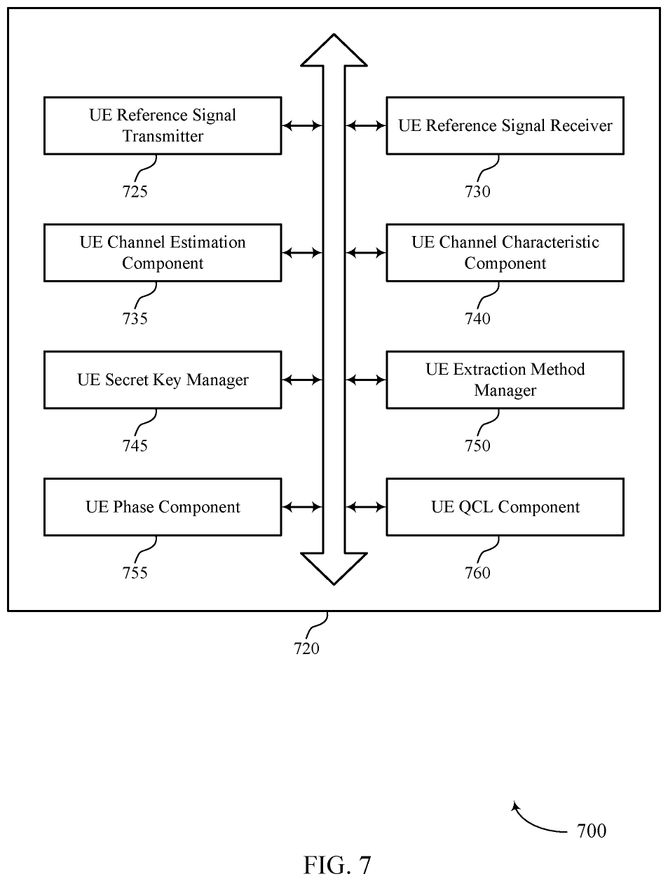

FIG. 7 shows a block diagram 700 of a communications manager 720 that supports secret key extraction for physical layer protection in a wireless communications system in accordance with aspects of the present disclosure. The communications manager 720 may be an example of aspects of a communications manager 520, a communications manager 620, or both, as described herein. The communications manager 720, or various components thereof, may be an example of means for performing various aspects of secret key extraction for physical layer protection in a wireless communications system as described herein. For example, the communications manager 720 may include a UE reference signal transmitter 725, a UE reference signal receiver 730, a UE channel estimation component 735, a UE channel characteristic component 740, a UE secret key manager 745, a UE extraction method manager 750, a UE phase component 755, a UE QCL component 760, or any combination thereof. Each of these components may communicate, directly or indirectly, with one another (e.g., via one or more buses).

The communications manager 720 may support wireless communication at a UE in accordance with examples as disclosed herein. The UE reference signal transmitter 725 may be configured as or otherwise support a means for transmitting, to a base station, one or more first reference signals. The UE reference signal receiver 730 may be configured as or otherwise support a means for receiving, from the base station in response to the one or more first reference signals, one or more second reference signals corresponding to a target value for a channel characteristic of a downlink channel between the UE and the base station. The UE channel estimation component 735 may be configured as or otherwise support a means for performing channel estimation on the downlink channel based on the one or more second reference signals. The UE channel characteristic component 740 may be configured as or otherwise support a means for estimating a value of the channel characteristic of the downlink channel based on performing the channel estimation. The UE secret key manager 745 may be configured as or otherwise support a means for generating a set of secret key bits based on the estimated value being within a range of the target value.

In some examples, the UE channel characteristic component 740 may be configured as or otherwise support a means for determining a quantized value of the estimated value of the channel characteristic, where the quantized value is the target value.

In some examples, to support generating the set of secret key bits, the UE secret key manager 745 may be configured as or otherwise support a means for determining a mapping between the target value and the set of secret key bits.

In some examples, to support generating the set of secret key bits, the UE secret key manager 745 may be configured as or otherwise support a means for inputting the target value into a function to generate a set of output values. In some examples, to support generating the set of secret key bits, the UE secret key manager 745 may be configured as or otherwise support a means for converting the set of output values into the set of secret key bits.

In some examples, the UE extraction method manager 750 may be configured as or otherwise support a means for receiving, from the base station, signaling that indicates the channel characteristic of the downlink channel, a set of resources for receiving the one or more second reference signals, or both.

In some examples, the signaling indicates the set of resources, and the UE extraction method manager 750 may be configured as or otherwise support a means for receiving, from the base station, an indication of a repetition factor for the one or more second reference signals, the repetition factor identifying a quantity of the one or more second reference signals that are to be received over the set of resources.

In some examples, the set of resources includes a portion of resources of a single slot or multiple slots.

In some examples, the UE phase component 755 may be configured as or otherwise support a means for determining a phase difference between transmitting a first signal via a port of the UE and receiving a second signal via the port of the UE, where the port is used by the UE to transmit the one or more first reference signals and receive the one or more second reference signals. In some examples, the UE phase component 755 may be configured as or otherwise support a means for transmitting, to the base station, an indication of the phase difference.

In some examples, the UE QCL component 760 may be configured as or otherwise support a means for determining a quasi-colocation relationship between one or more ports of the UE used to transmit the one or more first reference signals and one or more ports of the UE used to receive the one or more second reference signals, where estimating the value of the channel characteristic is based on the quasi-colocation relationship.

In some examples, the UE extraction method manager 750 may be configured as or otherwise support a means for receiving, from the base station, signaling instructing the UE to generate the set of secret key bits based on estimating the value of the channel characteristic when the UE operates according to a frequency division duplexing scheme.

In some examples, the UE extraction method manager 750 may be configured as or otherwise support a means for receiving, from the base station, control signaling indicating a set of modes for key extraction that includes at least a first mode and a second mode different from the first mode, where the first mode corresponds to the UE generating the set of secret key bits based on estimating the value of the channel characteristic. In some examples, the UE extraction method manager 750 may be configured as or otherwise support a means for receiving, from the base station, an indication to perform secret key extraction according to the first mode.

In some examples, the channel characteristic is based on a frequency dispersion or a time dispersion of the one or more second reference signals as received by the UE.

In some examples, the channel characteristic includes a delay spread, a doppler shift, or a doppler spread of the one or more second reference signals as received by the UE.

In some examples, an uplink channel between the UE and the base station corresponds to a first frequency range and the downlink channel corresponds to a second frequency range, the first frequency range different from the second frequency range.

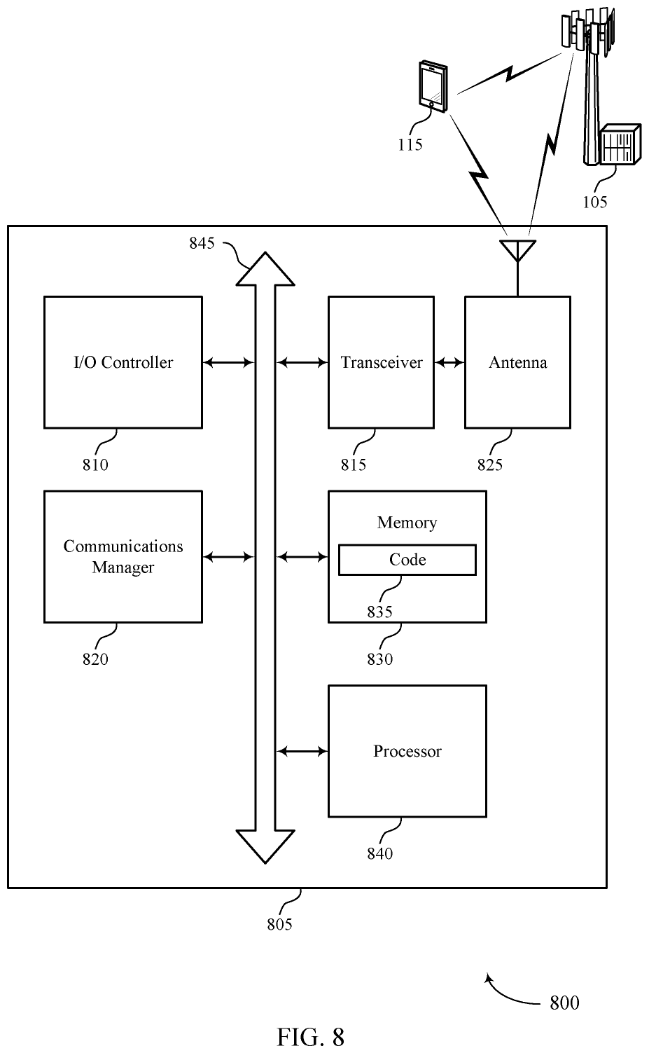

FIG. 8 shows a diagram of a system 800 including a device 805 that supports secret key extraction for physical layer protection in a wireless communications system in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®), LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting secret key extraction for physical layer protection in a wireless communications system). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for transmitting, to a base station, one or more first reference signals. The communications manager 820 may be configured as or otherwise support a means for receiving, from the base station in response to the one or more first reference signals, one or more second reference signals corresponding to a target value for a channel characteristic of a downlink channel between the UE and the base station. The communications manager 820 may be configured as or otherwise support a means for performing channel estimation on the downlink channel based on the one or more second reference signals. The communications manager 820 may be configured as or otherwise support a means for estimating a value of the channel characteristic of the downlink channel based on performing the channel estimation. The communications manager 820 may be configured as or otherwise support a means for generating a set of secret key bits based on the estimated value being within a range of the target value.

By including or configuring the communications manager 820 in accordance with examples as described herein, the device 805 may support techniques for improved communication reliability, more efficient utilization of communication resources, and improved physical layer protection. The methods as described herein may allow a device 805 to protect physical layer protection regardless of whether FDD or TDD is active. Traditional methods may allow provide physical layer protection if TDD is active. As such, the methods as described herein provide for improved physical layer protection in scenarios when FDD is active.

In some examples, the communications manager 820 may be configured to perform various operations (e.g., receiving, monitoring, transmitting) using or otherwise in cooperation with the transceiver 815, the one or more antennas 825, or any combination thereof. For example, the communications manager 820 may be configured to receive or transmit messages or other signaling as described herein via the transceiver 815. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of secret key extraction for physical layer protection in a wireless communications system as described herein, or the processor 840 and the memory 830 may be otherwise configured to perform or support such operations.

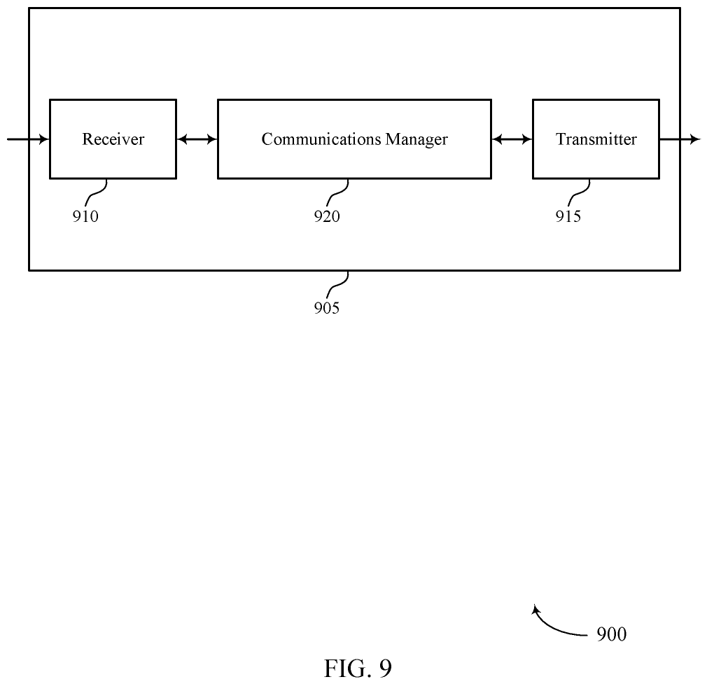

FIG. 9 shows a block diagram 900 of a device 905 that supports secret key extraction for physical layer protection in a wireless communications system in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to secret key extraction for physical layer protection in a wireless communications system). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to secret key extraction for physical layer protection in a wireless communications system). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of secret key extraction for physical layer protection in a wireless communications system as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. For example, the communications manager 920 may be configured as or otherwise support a means for receiving one or more first reference signals from a UE. The communications manager 920 may be configured as or otherwise support a means for performing channel estimation on an uplink channel between the UE and the base station based on the one or more first reference signals. The communications manager 920 may be configured as or otherwise support a means for estimating a value of a channel characteristic of the uplink channel based on performing the channel estimation. The communications manager 920 may be configured as or otherwise support a means for generating a set of secret key bits based on a target value of the channel characteristic of the uplink channel. The communications manager 920 may be configured as or otherwise support a means for generating, based on the estimated value and the target value, one or more second reference signals such that a channel characteristic of a downlink channel between the base station and the UE is within a range of the target value. The communications manager 920 may be configured as or otherwise support a means for transmitting, to the UE, the one or more second reference signals.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced processing and more efficient utilization of communication resources.

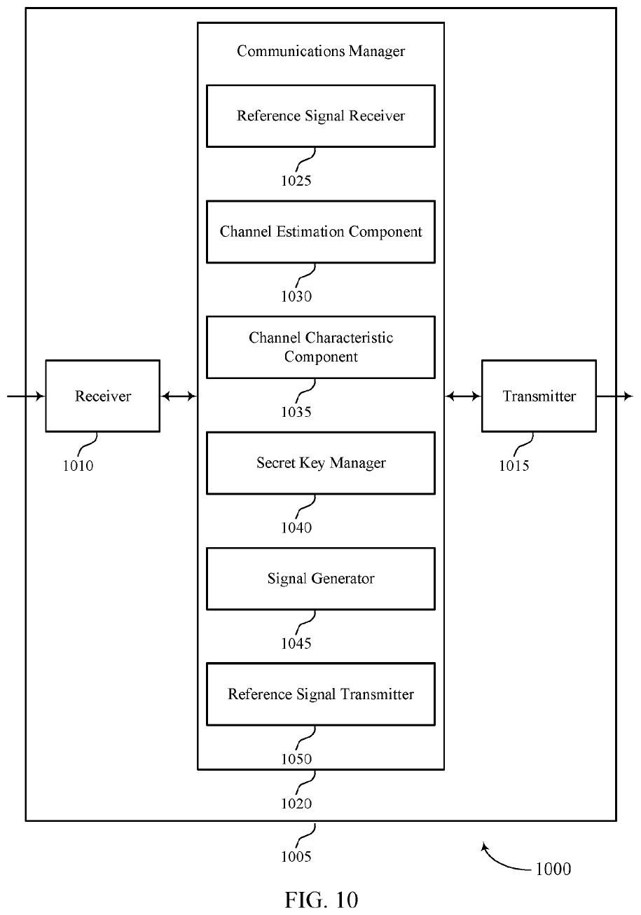

FIG. 10 shows a block diagram 1000 of a device 1005 that supports secret key extraction for physical layer protection in a wireless communications system in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to secret key extraction for physical layer protection in a wireless communications system). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to secret key extraction for physical layer protection in a wireless communications system). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of secret key extraction for physical layer protection in a wireless communications system as described herein. For example, the communications manager 1020 may include a reference signal receiver 1025, a channel estimation component 1030, a channel characteristic component 1035, a secret key manager 1040, a signal generator 1045, a reference signal transmitter 1050, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. The reference signal receiver 1025 may be configured as or otherwise support a means for receiving one or more first reference signals from a UE. The channel estimation component 1030 may be configured as or otherwise support a means for performing channel estimation on an uplink channel between the UE and the base station based on the one or more first reference signals. The channel characteristic component 1035 may be configured as or otherwise support a means for estimating a value of a channel characteristic of the uplink channel based on performing the channel estimation. The secret key manager 1040 may be configured as or otherwise support a means for generating a set of secret key bits based on a target value of the channel characteristic of the uplink channel. The signal generator 1045 may be configured as or otherwise support a means for generating, based on the estimated value and the target value, one or more second reference signals such that a channel characteristic of a downlink channel between the base station and the UE is within a range of the target value. The reference signal transmitter 1050 may be configured as or otherwise support a means for transmitting, to the UE, the one or more second reference signals.

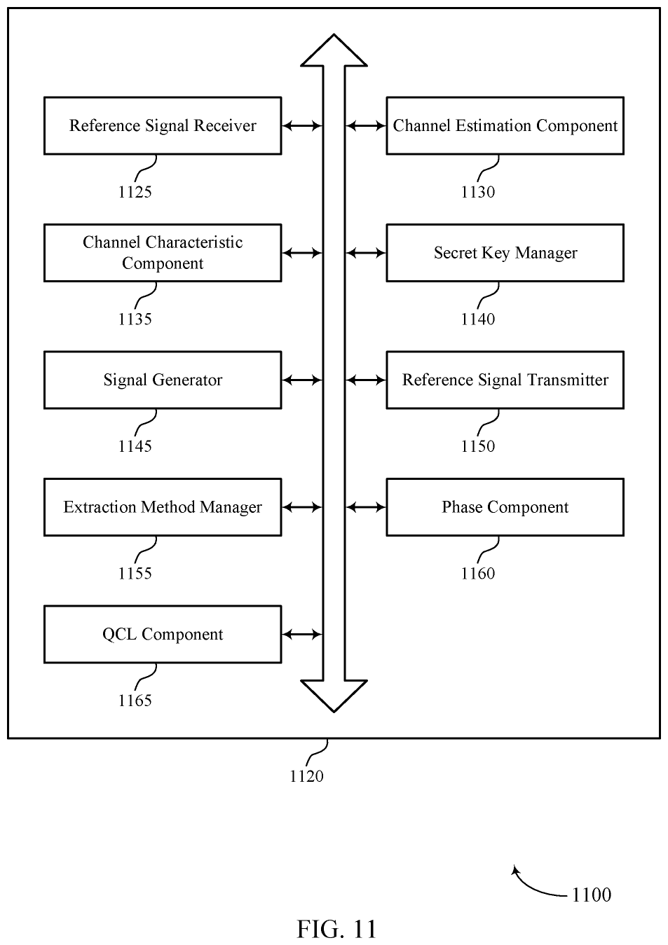

FIG. 11 shows a block diagram 1100 of a communications manager 1120 that supports secret key extraction for physical layer protection in a wireless communications system in accordance with aspects of the present disclosure. The communications manager 1120 may be an example of aspects of a communications manager 920, a communications manager 1020, or both, as described herein. The communications manager 1120, or various components thereof, may be an example of means for performing various aspects of secret key extraction for physical layer protection in a wireless communications system as described herein. For example, the communications manager 1120 may include a reference signal receiver 1125, a channel estimation component 1130, a channel characteristic component 1135, a secret key manager 1140, a signal generator 1145, a reference signal transmitter 1150, an extraction method manager 1155, a phase component 1160, a QCL component 1165, or any combination thereof. Each of these components may communicate, directly or indirectly, with one another (e.g., via one or more buses).

The communications manager 1120 may support wireless communication at a base station in accordance with examples as disclosed herein. The reference signal receiver 1125 may be configured as or otherwise support a means for receiving one or more first reference signals from a UE. The channel estimation component 1130 may be configured as or otherwise support a means for performing channel estimation on an uplink channel between the UE and the base station based on the one or more first reference signals. The channel characteristic component 1135 may be configured as or otherwise support a means for estimating a value of a channel characteristic of the uplink channel based on performing the channel estimation. The secret key manager 1140 may be configured as or otherwise support a means for generating a set of secret key bits based on a target value of the channel characteristic of the uplink channel. The signal generator 1145 may be configured as or otherwise support a means for generating, based on the estimated value and the target value, one or more second reference signals such that a channel characteristic of a downlink channel between the base station and the UE is within a range of the target value. The reference signal transmitter 1150 may be configured as or otherwise support a means for transmitting, to the UE, the one or more second reference signals.

In some examples, the channel characteristic component 1135 may be configured as or otherwise support a means for determining a quantized value of the estimated value of the channel characteristic of the uplink channel, where the quantized value of the estimated value is the target value of the channel characteristic of the uplink channel.

In some examples, the channel characteristic component 1135 may be configured as or otherwise support a means for selecting the target value of the channel characteristic of the uplink channel from a set of values, where the set of values is stored at the base station and each value of the set of values corresponds to a different set of secret key bits.

In some examples, to support generating the set of secret key bits, the secret key manager 1140 may be configured as or otherwise support a means for determining a mapping between the target value of the channel characteristic of the uplink channel and the set of secret key bits.

In some examples, to support generating the set of secret key bits, the secret key manager 1140 may be configured as or otherwise support a means for inputting the target value of the channel characteristic of the uplink channel into a function to generate a set of output values. In some examples, to support generating the set of secret key bits, the secret key manager 1140 may be configured as or otherwise support a means for converting the set of output values into the set of secret key bits.

In some examples, to support generating the one or more second reference signals, the signal generator 1145 may be configured as or otherwise support a means for applying a frequency offset to the one or more second reference signals, the frequency offset based on the value of the channel characteristic of the uplink channel and the target value of the channel characteristic of the uplink channel. In some examples, to support generating the one or more second reference signals, the signal generator 1145 may be configured as or otherwise support a means for applying a timing offset to the one or more second reference signals, the timing offset based on the value of the channel characteristic of the uplink channel and the target value of the channel characteristic of the uplink channel. In some examples, to support generating the one or more second reference signals, the signal generator 1145 may be configured as or otherwise support a means for modifying a precoder corresponding to one or more ports associated with resources used to transmit the one or more first reference signals and receive the one or more second reference signals, the modifying based on the value of the channel characteristic of the uplink channel and the target value of the channel characteristic of the uplink channel.

In some examples, the channel characteristic of the uplink channel includes a delay spread and, to support estimating the value of the channel characteristic of the uplink channel, the channel characteristic component 1135 may be configured as or otherwise support a means for estimating a respective channel impulse response and a respective power delay profile for each port of at least two ports of the base station, where the at least two ports are used by the base station to receive the one or more first reference signals.

In some examples, to support generating the one or more second reference signals, the signal generator 1145 may be configured as or otherwise support a means for applying a cyclic shift to the one or more second reference signals based on the estimated respective channel impulse response and the estimated respective power delay profile for each port of the at least two ports.

In some examples, the extraction method manager 1155 may be configured as or otherwise support a means for transmitting, to the UE, signaling that indicates the channel characteristic of the downlink channel, a set of resources for the UE to use to receive the one or more second reference signals, or both.

In some examples, the signaling indicates the set of resources, and the extraction method manager 1155 may be configured as or otherwise support a means for transmitting, to the UE, an indication of a repetition factor for the one or more second reference signals, the repetition factor identifying a quantity of the or more second reference signals to be received by the UE over the set of resources.

In some examples, the set of resources includes a portion of resources of a single slot or multiple slots.

In some examples, the phase component 1160 may be configured as or otherwise support a means for receiving, from the UE, an indication of a phase difference between transmitting a first signal via a port of the UE and receiving a second signal via the port of the UE, where the port is used by the UE to transmit the one or more first reference signals and receive the one or more second reference signals, and where generating the one or more second reference signals is based on the phase difference.

In some examples, the QCL component 1165 may be configured as or otherwise support a means for determining a quasi-colocation relationship between one or more ports used to receive the one or more first reference signals and one or more ports used to transmit the one or more second reference signals, where estimating the value of the channel characteristic of the uplink channel is based on the quasi-colocation relationship.

In some examples, the extraction method manager 1155 may be configured as or otherwise support a means for transmitting, to the UE, signaling instructing the UE to obtain the set of secret key bits based on estimating a value of the channel characteristic of the downlink channel when the UE operates according to a frequency division duplexing scheme.

In some examples, the extraction method manager 1155 may be configured as or otherwise support a means for transmitting, to the UE, control signaling indicating a set of modes for key extraction that includes at least a first mode and a second mode different from the first mode, where the first mode corresponds to the UE generating the set of secret key bits based on estimating a value of the channel characteristic of the downlink channel. In some examples, the extraction method manager 1155 may be configured as or otherwise support a means for transmitting, to the UE, an indication to perform secret key extraction according to the first mode.

In some examples, the channel characteristic of the uplink channel is based on a frequency dispersion or a time dispersion of the one or more first reference signals as received by the base station.

In some examples, the channel characteristic of the uplink channel includes a delay spread, a doppler shift, or a doppler spread of the one or more first reference signals as received by the base station.

In some examples, the uplink channel corresponds to a first frequency range and the downlink channel corresponds to a second frequency range, the first frequency range different from the second frequency range.

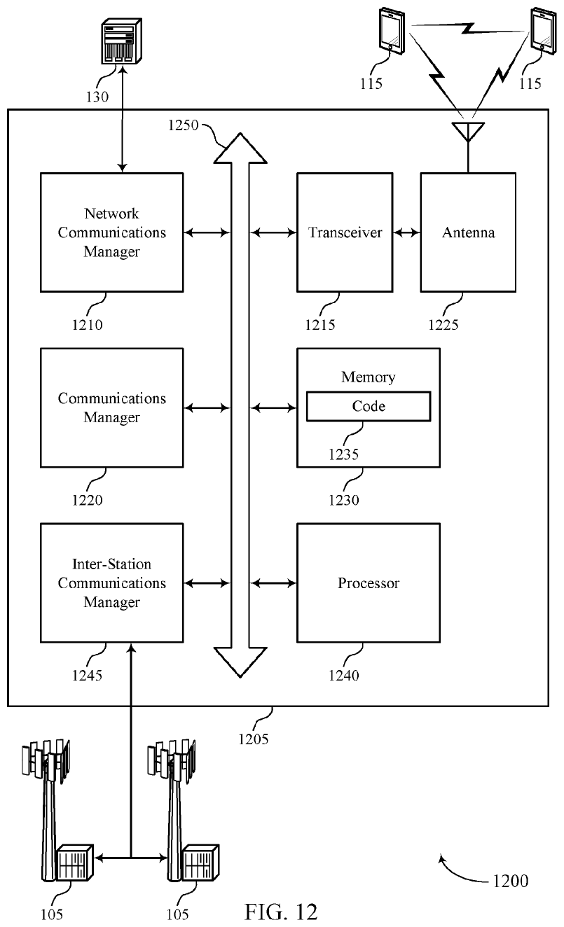

FIG. 12 shows a diagram of a system 1200 including a device 1205 that supports secret key extraction for physical layer protection in a wireless communications system in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting secret key extraction for physical layer protection in a wireless communications system). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a base station in accordance with examples as disclosed herein. For example, the communications manager 1220 may be configured as or otherwise support a means for receiving one or more first reference signals from a UE. The communications manager 1220 may be configured as or otherwise support a means for performing channel estimation on an uplink channel between the UE and the base station based on the one or more first reference signals. The communications manager 1220 may be configured as or otherwise support a means for estimating a value of a channel characteristic of the uplink channel based on performing the channel estimation. The communications manager 1220 may be configured as or otherwise support a means for generating a set of secret key bits based on a target value of the channel characteristic of the uplink channel. The communications manager 1220 may be configured as or otherwise support a means for generating, based on the estimated value and the target value, one or more second reference signals such that a channel characteristic of a downlink channel between the base station and the UE is within a range of the target value. The communications manager 1220 may be configured as or otherwise support a means for transmitting, to the UE, the one or more second reference signals.

By including or configuring the communications manager 1220 in accordance with examples as described herein, the device 1205 may support techniques for more efficient utilization of communication resources.

In some examples, the communications manager 1220 may be configured to perform various operations (e.g., receiving, monitoring, transmitting) using or otherwise in cooperation with the transceiver 1215, the one or more antennas 1225, or any combination thereof. For example, the communications manager 1220 may be configured to receive or transmit messages or other signaling as described herein via the transceiver 1215. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of secret key extraction for physical layer protection in a wireless communications system as described herein, or the processor 1240 and the memory 1230 may be otherwise configured to perform or support such operations.

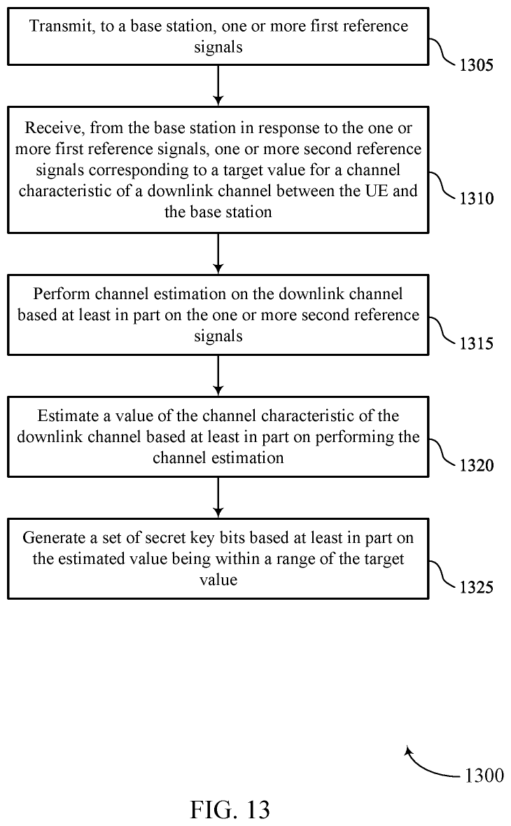

FIG. 13 shows a flowchart illustrating a method 1300 that supports secret key extraction for physical layer protection in a wireless communications system in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include transmitting, to a base station, one or more first reference signals. The operations of 1305 may be performed in accordance with examples as disclosed herein. In some examples, aspects of the operations of 1305 may be performed by a UE reference signal transmitter 725 as described with reference to FIG. 7. Additionally or alternatively, means for performing 1305 may, but not necessarily, include, for example, antenna 825, transceiver 815, communications manager 820, memory 830 (including code 835), processor 840, and/or bus 845.

At 1310, the method may include receiving, from the base station in response to the one or more first reference signals, one or more second reference signals corresponding to a target value for a channel characteristic of a downlink channel between the UE and the base station. The operations of 1310 may be performed in accordance with examples as disclosed herein. In some examples, aspects of the operations of 1310 may be performed by a UE reference signal receiver 730 as described with reference to FIG. 7. Additionally or alternatively, means for performing 1310 may, but not necessarily, include, for example, antenna 825, transceiver 815, communications manager 820, memory 830 (including code 835), processor 840, and/or bus 845.

At 1315, the method may include performing channel estimation on the downlink channel based on the one or more second reference signals. The operations of 1315 may be performed in accordance with examples as disclosed herein. In some examples, aspects of the operations of 1315 may be performed by a UE channel estimation component 735 as described with reference to FIG. 7. Additionally or alternatively, means for performing 1315 may, but not necessarily, include, for example, antenna 825, transceiver 815, communications manager 820, memory 830 (including code 835), processor 840, and/or bus 845.

At 1320, the method may include estimating a value of the channel characteristic of the downlink channel based on performing the channel estimation. The operations of 1320 may be performed in accordance with examples as disclosed herein. In some examples, aspects of the operations of 1320 may be performed by a UE channel characteristic component 740 as described with reference to FIG. 7. Additionally or alternatively, means for performing 1320 may, but not necessarily, include, for example, antenna 825, transceiver 815, communications manager 820, memory 830 (including code 835), processor 840, and/or bus 845.

At 1325, the method may include generating a set of secret key bits based on the estimated value being within a range of the target value. The operations of 1325 may be performed in accordance with examples as disclosed herein. In some examples, aspects of the operations of 1325 may be performed by a UE secret key manager 745 as described with reference to FIG. 7. Additionally or alternatively, means for performing 1325 may, but not necessarily, include, for example, antenna 825, transceiver 815, communications manager 820, memory 830 (including code 835), processor 840, and/or bus 845.

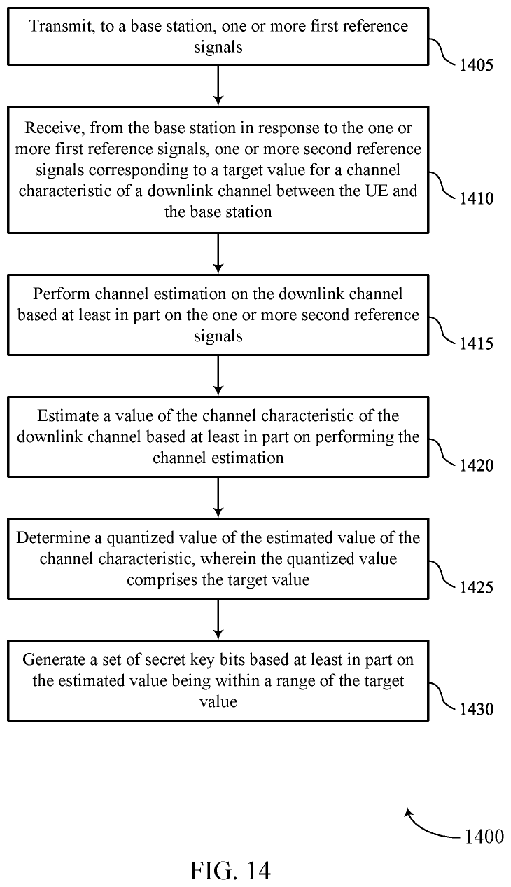

FIG. 14 shows a flowchart illustrating a method 1400 that supports secret key extraction for physical layer protection in a wireless communications system in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include transmitting, to a base station, one or more first reference signals. The operations of 1405 may be performed in accordance with examples as disclosed herein. In some examples, aspects of the operations of 1405 may be performed by a UE reference signal transmitter 725 as described with reference to FIG. 7. Additionally or alternatively, means for performing 1405 may, but not necessarily, include, for example, antenna 825, transceiver 815, communications manager 820, memory 830 (including code 835), processor 840, and/or bus 845.

At 1410, the method may include receiving, from the base station in response to the one or more first reference signals, one or more second reference signals corresponding to a target value for a channel characteristic of a downlink channel between the UE and the base station. The operations of 1410 may be performed in accordance with examples as disclosed herein. In some examples, aspects of the operations of 1410 may be performed by a UE reference signal receiver 730 as described with reference to FIG. 7. Additionally or alternatively, means for performing 1410 may, but not necessarily, include, for example, antenna 825, transceiver 815, communications manager 820, memory 830 (including code 835), processor 840, and/or bus 845.

At 1415, the method may include performing channel estimation on the downlink channel based on the one or more second reference signals. The operations of 1415 may be performed in accordance with examples as disclosed herein. In some examples, aspects of the operations of 1415 may be performed by a UE channel estimation component 735 as described with reference to FIG. 7. Additionally or alternatively, means for performing 1415 may, but not necessarily, include, for example, antenna 825, transceiver 815, communications manager 820, memory 830 (including code 835), processor 840, and/or bus 845.

At 1420, the method may include estimating a value of the channel characteristic of the downlink channel based on performing the channel estimation. The operations of 1420 may be performed in accordance with examples as disclosed herein. In some examples, aspects of the operations of 1420 may be performed by a UE channel characteristic component 740 as described with reference to FIG. 7. Additionally or alternatively, means for performing 1420 may, but not necessarily, include, for example, antenna 825, transceiver 815, communications manager 820, memory 830 (including code 835), processor 840, and/or bus 845.

At 1425, the method may include determining a quantized value of the estimated value of the channel characteristic, where the quantized value is the target value. The operations of 1425 may be performed in accordance with examples as disclosed herein. In some examples, aspects of the operations of 1425 may be performed by a UE channel characteristic component 740 as described with reference to FIG. 7. Additionally or alternatively, means for performing 1425 may, but not necessarily, include, for example, antenna 825, transceiver 815, communications manager 820, memory 830 (including code 835), processor 840, and/or bus 845.

At 1430, the method may include generating a set of secret key bits based on the estimated value being within a range of the target value. The operations of 1430 may be performed in accordance with examples as disclosed herein. In some examples, aspects of the operations of 1430 may be performed by a UE secret key manager 745 as described with reference to FIG. 7. Additionally or alternatively, means for performing 1430 may, but not necessarily, include, for example, antenna 825, transceiver 815, communications manager 820, memory 830 (including code 835), processor 840, and/or bus 845.

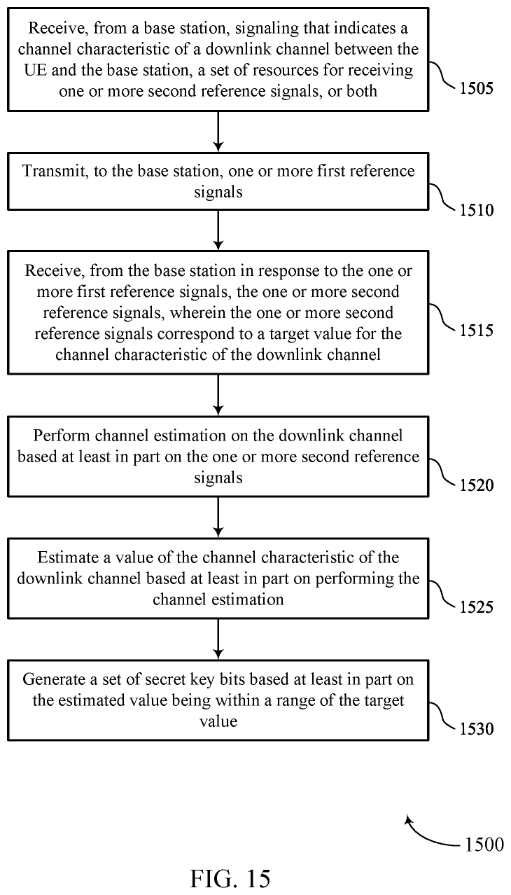

FIG. 15 shows a flowchart illustrating a method 1500 that supports secret key extraction for physical layer protection in a wireless communications system in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, signaling that indicates a channel characteristic of a downlink channel between the UE and a base station, a set of resources for receiving one or more second reference signals, or both. The operations of 1505 may be performed in accordance with examples as disclosed herein. In some examples, aspects of the operations of 1505 may be performed by a UE extraction method manager 750 as described with reference to FIG. 7. Additionally or alternatively, means for performing 1505 may, but not necessarily, include, for example, antenna 825, transceiver 815, communications manager 820, memory 830 (including code 835), processor 840, and/or bus 845.

At 1510, the method may include transmitting, to the base station, one or more first reference signals. The operations of 1510 may be performed in accordance with examples as disclosed herein. In some examples, aspects of the operations of 1510 may be performed by a UE reference signal transmitter 725 as described with reference to FIG. 7. Additionally or alternatively, means for performing 1510 may, but not necessarily, include, for example, antenna 825, transceiver 815, communications manager 820, memory 830 (including code 835), processor 840, and/or bus 845.

At 1515, the method may include receiving, from the base station in response to the one or more first reference signals, the one or more second reference signals, where the one or more second reference signals correspond to a target value for the channel characteristic of the downlink channel. The operations of 1515 may be performed in accordance with examples as disclosed herein. In some examples, aspects of the operations of 1515 may be performed by a UE reference signal receiver 730 as described with reference to FIG. 7. Additionally or alternatively, means for performing 1515 may, but not necessarily, include, for example, antenna 825, transceiver 815, communications manager 820, memory 830 (including code 835), processor 840, and/or bus 845.

At 1520, the method may include performing channel estimation on the downlink channel based on the one or more second reference signals. The operations of 1520 may be performed in accordance with examples as disclosed herein. In some examples, aspects of the operations of 1520 may be performed by a UE channel estimation component 735 as described with reference to FIG. 7. Additionally or alternatively, means for performing 1520 may, but not necessarily, include, for example, antenna 825, transceiver 815, communications manager 820, memory 830 (including code 835), processor 840, and/or bus 845.

At 1525, the method may include estimating a value of the channel characteristic of the downlink channel based on performing the channel estimation. The operations of 1525 may be performed in accordance with examples as disclosed herein. In some examples, aspects of the operations of 1525 may be performed by a UE channel characteristic component 740 as described with reference to FIG. 7. Additionally or alternatively, means for performing 1525 may, but not necessarily, include, for example, antenna 825, transceiver 815, communications manager 820, memory 830 (including code 835), processor 840, and/or bus 845.

At 1530, the method may include generating a set of secret key bits based on the estimated value being within a range of the target value. The operations of 1530 may be performed in accordance with examples as disclosed herein. In some examples, aspects of the operations of 1530 may be performed by a UE secret key manager 745 as described with reference to FIG. 7. Additionally or alternatively, means for performing 1530 may, but not necessarily, include, for example, antenna 825, transceiver 815, communications manager 820, memory 830 (including code 835), processor 840, and/or bus 845.

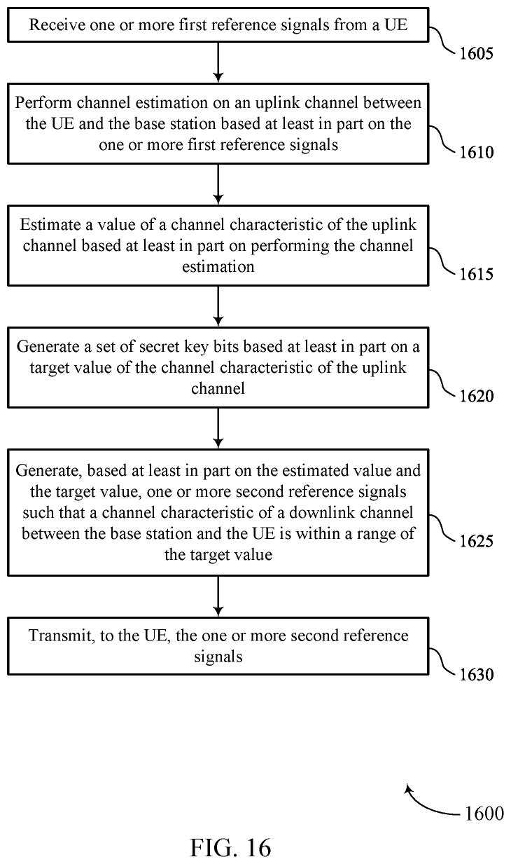

FIG. 16 shows a flowchart illustrating a method 1600 that supports secret key extraction for physical layer protection in a wireless communications system in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include receiving one or more first reference signals from a UE. The operations of 1605 may be performed in accordance with examples as disclosed herein. In some examples, aspects of the operations of 1605 may be performed by a reference signal receiver 1125 as described with reference to FIG. 11. Additionally or alternatively, means for performing 1605 may, but not necessarily, include, for example, antenna 1225, transceiver 1215, communications manager 1220, memory 1230 (including code 1235), processor 1240, and/or bus 1250.

At 1610, the method may include performing channel estimation on an uplink channel between the UE and the base station based on the one or more first reference signals. The operations of 1610 may be performed in accordance with examples as disclosed herein. In some examples, aspects of the operations of 1610 may be performed by a channel estimation component 1130 as described with reference to FIG. 11. Additionally or alternatively, means for performing 1610 may, but not necessarily, include, for example, antenna 1225, transceiver 1215, communications manager 1220, memory 1230 (including code 1235), processor 1240, and/or bus 1250.

At 1615, the method may include estimating a value of a channel characteristic of the uplink channel based on performing the channel estimation. The operations of 1615 may be performed in accordance with examples as disclosed herein. In some examples, aspects of the operations of 1615 may be performed by a channel characteristic component 1135 as described with reference to FIG. 11. Additionally or alternatively, means for performing 1615 may, but not necessarily, include, for example, antenna 1225, transceiver 1215, communications manager 1220, memory 1230 (including code 1235), processor 1240, and/or bus 1250.

At 1620, the method may include generating a set of secret key bits based on a target value of the channel characteristic of the uplink channel. The operations of 1620 may be performed in accordance with examples as disclosed herein. In some examples, aspects of the operations of 1620 may be performed by a secret key manager 1140 as described with reference to FIG. 11. Additionally or alternatively, means for performing 1620 may, but not necessarily, include, for example, antenna 1225, transceiver 1215, communications manager 1220, memory 1230 (including code 1235), processor 1240, and/or bus 1250.

At 1625, the method may include generating, based on the estimated value and the target value, one or more second reference signals such that a channel characteristic of a downlink channel between the base station and the UE is within a range of the target value. The operations of 1625 may be performed in accordance with examples as disclosed herein. In some examples, aspects of the operations of 1625 may be performed by a signal generator 1145 as described with reference to FIG. 11. Additionally or alternatively, means for performing 1625 may, but not necessarily, include, for example, antenna 1225, transceiver 1215, communications manager 1220, memory 1230 (including code 1235), processor 1240, and/or bus 1250.

At 1630, the method may include transmitting, to the UE, the one or more second reference signals. The operations of 1630 may be performed in accordance with examples as disclosed herein. In some examples, aspects of the operations of 1630 may be performed by a reference signal transmitter 1150 as described with reference to FIG. 11. Additionally or alternatively, means for performing 1630 may, but not necessarily, include, for example, antenna 1225, transceiver 1215, communications manager 1220, memory 1230 (including code 1235), processor 1240, and/or bus 1250.

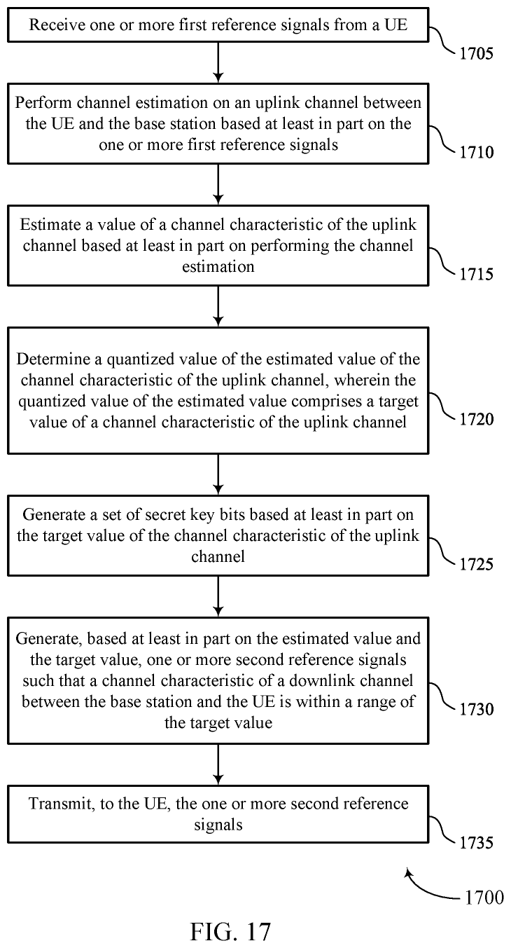

FIG. 17 shows a flowchart illustrating a method 1700 that supports secret key extraction for physical layer protection in a wireless communications system in accordance with aspects of the present disclosure. The operations of the method 1700 may be implemented by a base station or its components as described herein. For example, the operations of the method 1700 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1705, the method may include receiving one or more first reference signals from a UE. The operations of 1705 may be performed in accordance with examples as disclosed herein. In some examples, aspects of the operations of 1705 may be performed by a reference signal receiver 1125 as described with reference to FIG. 11. Additionally or alternatively, means for performing 1705 may, but not necessarily, include, for example, antenna 1225, transceiver 1215, communications manager 1220, memory 1230 (including code 1235), processor 1240, and/or bus 1250.

At 1710, the method may include performing channel estimation on an uplink channel between the UE and the base station based on the one or more first reference signals. The operations of 1710 may be performed in accordance with examples as disclosed herein. In some examples, aspects of the operations of 1710 may be performed by a channel estimation component 1130 as described with reference to FIG. 11. Additionally or alternatively, means for performing 1710 may, but not necessarily, include, for example, antenna 1225, transceiver 1215, communications manager 1220, memory 1230 (including code 1235), processor 1240, and/or bus 1250.

At 1715, the method may include estimating a value of a channel characteristic of the uplink channel based on performing the channel estimation. The operations of 1715 may be performed in accordance with examples as disclosed herein. In some examples, aspects of the operations of 1715 may be performed by a channel characteristic component 1135 as described with reference to FIG. 11. Additionally or alternatively, means for performing 1715 may, but not necessarily, include, for example, antenna 1225, transceiver 1215, communications manager 1220, memory 1230 (including code 1235), processor 1240, and/or bus 1250.

At 1720, the method may include determining a quantized value of the estimated value of the channel characteristic of the uplink channel, where the quantized value of the estimated value is a target value of a channel characteristic of the uplink channel. The operations of 1720 may be performed in accordance with examples as disclosed herein. In some examples, aspects of the operations of 1720 may be performed by a channel characteristic component 1135 as described with reference to FIG. 11. Additionally or alternatively, means for performing 1720 may, but not necessarily, include, for example, antenna 1225, transceiver 1215, communications manager 1220, memory 1230 (including code 1235), processor 1240, and/or bus 1250.

At 1725, the method may include generating a set of secret key bits based on the target value of the channel characteristic of the uplink channel. The operations of 1725 may be performed in accordance with examples as disclosed herein. In some examples, aspects of the operations of 1725 may be performed by a secret key manager 1140 as described with reference to FIG. 11. Additionally or alternatively, means for performing 1725 may, but not necessarily, include, for example, antenna 1225, transceiver 1215, communications manager 1220, memory 1230 (including code 1235), processor 1240, and/or bus 1250.

At 1730, the method may include generating, based on the estimated value and the target value, one or more second reference signals such that a channel characteristic of a downlink channel between the base station and the UE is within a range of the target value. The operations of 1730 may be performed in accordance with examples as disclosed herein. In some examples, aspects of the operations of 1730 may be performed by a signal generator 1145 as described with reference to FIG. 11. Additionally or alternatively, means for performing 1730 may, but not necessarily, include, for example, antenna 1225, transceiver 1215, communications manager 1220, memory 1230 (including code 1235), processor 1240, and/or bus 1250.

At 1735, the method may include transmitting, to the UE, the one or more second reference signals. The operations of 1735 may be performed in accordance with examples as disclosed herein. In some examples, aspects of the operations of 1735 may be performed by a reference signal transmitter 1150 as described with reference to FIG. 11. Additionally or alternatively, means for performing 1735 may, but not necessarily, include, for example, antenna 1225, transceiver 1215, communications manager 1220, memory 1230 (including code 1235), processor 1240, and/or bus 1250.

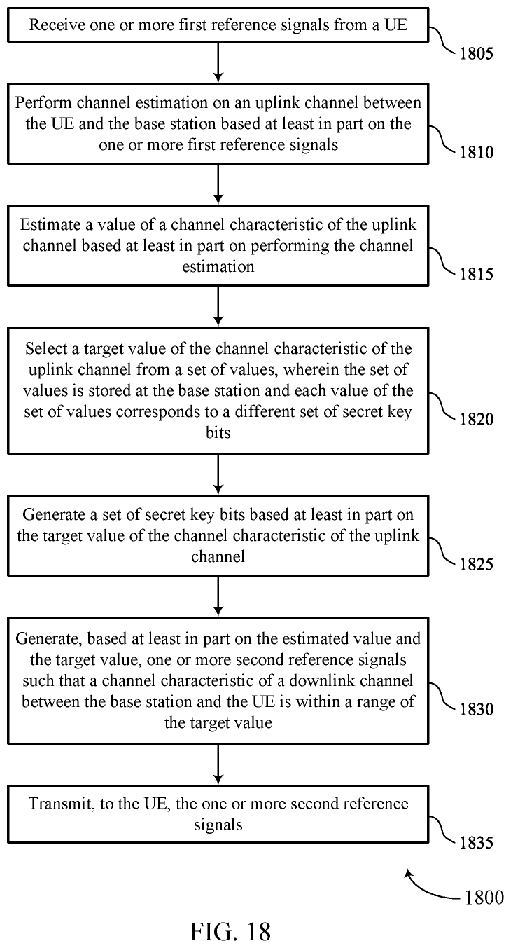

FIG. 18 shows a flowchart illustrating a method 1800 that supports secret key extraction for physical layer protection in a wireless communications system in accordance with aspects of the present disclosure. The operations of the method 1800 may be implemented by a base station or its components as described herein. For example, the operations of the method 1800 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1805, the method may include receiving one or more first reference signals from a UE. The operations of 1805 may be performed in accordance with examples as disclosed herein. In some examples, aspects of the operations of 1805 may be performed by a reference signal receiver 1125 as described with reference to FIG. 11. Additionally or alternatively, means for performing 1805 may, but not necessarily, include, for example, antenna 1225, transceiver 1215, communications manager 1220, memory 1230 (including code 1235), processor 1240, and/or bus 1250.

At 1810, the method may include performing channel estimation on an uplink channel between the UE and the base station based on the one or more first reference signals. The operations of 1810 may be performed in accordance with examples as disclosed herein. In some examples, aspects of the operations of 1810 may be performed by a channel estimation component 1130 as described with reference to FIG. 11. Additionally or alternatively, means for performing 1810 may, but not necessarily, include, for example, antenna 1225, transceiver 1215, communications manager 1220, memory 1230 (including code 1235), processor 1240, and/or bus 1250.

At 1815, the method may include estimating a value of a channel characteristic of the uplink channel based on performing the channel estimation. The operations of 1815 may be performed in accordance with examples as disclosed herein. In some examples, aspects of the operations of 1815 may be performed by a channel characteristic component 1135 as described with reference to FIG. 11. Additionally or alternatively, means for performing 1815 may, but not necessarily, include, for example, antenna 1225, transceiver 1215, communications manager 1220, memory 1230 (including code 1235), processor 1240, and/or bus 1250.

At 1820, the method may include selecting a target value of the channel characteristic of the uplink channel from a set of values, where the set of values is stored at the base station and each value of the set of values corresponds to a different set of secret key bits. The operations of 1820 may be performed in accordance with examples as disclosed herein. In some examples, aspects of the operations of 1820 may be performed by a channel characteristic component 1135 as described with reference to FIG. 11. Additionally or alternatively, means for performing 1820 may, but not necessarily, include, for example, antenna 1225, transceiver 1215, communications manager 1220, memory 1230 (including code 1235), processor 1240, and/or bus 1250.

At 1825, the method may include generating a set of secret key bits based on the target value of the channel characteristic of the uplink channel. The operations of 1825 may be performed in accordance with examples as disclosed herein. In some examples, aspects of the operations of 1825 may be performed by a secret key manager 1140 as described with reference to FIG. 11. Additionally or alternatively, means for performing 1825 may, but not necessarily, include, for example, antenna 1225, transceiver 1215, communications manager 1220, memory 1230 (including code 1235), processor 1240, and/or bus 1250.

At 1830, the method may include generating, based on the estimated value and the target value, one or more second reference signals such that a channel characteristic of a downlink channel between the base station and the UE is within a range of the target value. The operations of 1830 may be performed in accordance with examples as disclosed herein. In some examples, aspects of the operations of 1830 may be performed by a signal generator 1145 as described with reference to FIG. 11. Additionally or alternatively, means for performing 1830 may, but not necessarily, include, for example, antenna 1225, transceiver 1215, communications manager 1220, memory 1230 (including code 1235), processor 1240, and/or bus 1250.

At 1835, the method may include transmitting, to the UE, the one or more second reference signals. The operations of 1835 may be performed in accordance with examples as disclosed herein. In some examples, aspects of the operations of 1835 may be performed by a reference signal transmitter 1150 as described with reference to FIG. 11. Additionally or alternatively, means for performing 1835 may, but not necessarily, include, for example, antenna 1225, transceiver 1215, communications manager 1220, memory 1230 (including code 1235), processor 1240, and/or bus 1250.

The following provides an overview of aspects of the present disclosure:

Aspect 1: A method for wireless communication at a UE, comprising: transmitting, to a base station, one or more first reference signals: receiving, from the base station in response to the one or more first reference signals, one or more second reference signals corresponding to a target value for a channel characteristic of a downlink channel between the UE and the base station: performing channel estimation on the downlink channel based at least in part on the one or more second reference signals: estimating a value of the channel characteristic of the downlink channel based at least in part on performing the channel estimation; and generating a set of secret key bits based at least in part on the estimated value being within a range of the target value.

Aspect 2: The method of aspect 1, further comprising: determining a quantized value of the estimated value of the channel characteristic, wherein the quantized value comprises the target value.

Aspect 3: The method of any of aspects 1 through 2, wherein generating the set of secret key bits comprises: determining a mapping between the target value and the set of secret key bits.

Aspect 4: The method of any of aspects 1 through 3, wherein generating the set of secret key bits comprises: inputting the target value into a function to generate a set of output values; and converting the set of output values into the set of secret key bits.

Aspect 5: The method of any of aspects 1 through 4, further comprising: receiving, from the base station, signaling that indicates the channel characteristic of the downlink channel, a set of resources for receiving the one or more second reference signals, or both.

Aspect 6: The method of aspect 5, wherein the signaling indicates the set of resources, the method further comprising: receiving, from the base station, an indication of a repetition factor for the one or more second reference signals, the repetition factor identifying a quantity of the one or more second reference signals that are to be received over the set of resources.

Aspect 7: The method of aspect 6, wherein the set of resources comprises a portion of resources of a single slot or multiple slots.

Aspect 8: The method of any of aspects 1 through 7, further comprising: determining a phase difference between transmitting a first signal via a port of the UE and receiving a second signal via the port of the UE, wherein the port is used by the UE to transmit the one or more first reference signals and receive the one or more second reference signals; and transmitting, to the base station, an indication of the phase difference.

Aspect 9: The method of any of aspects 1 through 8, further comprising: determining a QCL relationship between one or more ports of the UE used to transmit the one or more first reference signals and one or more ports of the UE used to receive the one or more second reference signals, wherein estimating the value of the channel characteristic is based at least in part on the QCL relationship.

Aspect 10: The method of any of aspects 1 through 9, further comprising: receiving, from the base station, signaling instructing the UE to generate the set of secret key bits based at least in part on estimating the value of the channel characteristic when the UE operates according to an FDD scheme.

Aspect 11: The method of any of aspects 1 through 10, further comprising: receiving, from the base station, control signaling indicating a set of modes for key extraction that comprises at least a first mode and a second mode different from the first mode, wherein the first mode corresponds to the UE generating the set of secret key bits based at least in part on estimating the value of the channel characteristic; and receiving, from the base station, an indication to perform secret key extraction according to the first mode.

Aspect 12: The method of any of aspects 1 through 11, wherein the channel characteristic is based at least in part on a frequency dispersion or a time dispersion of the one or more second reference signals as received by the UE.

Aspect 13: The method of aspect 12, wherein the channel characteristic comprises a delay spread, a doppler shift, or a doppler spread of the one or more second reference signals as received by the UE.

Aspect 14: The method of any of aspects 1 through 13, wherein an uplink channel between the UE and the base station corresponds to a first frequency range and the downlink channel corresponds to a second frequency range, the first frequency range different from the second frequency range.

Aspect 15: A method for wireless communication at a base station, comprising: receiving one or more first reference signals from a UE: performing channel estimation on an uplink channel between the UE and the base station based at least in part on the one or more first reference signals: estimating a value of a channel characteristic of the uplink channel based at least in part on performing the channel estimation: generating a set of secret key bits based at least in part on a target value of the channel characteristic of the uplink channel: generating, based at least in part on the estimated value and the target value, one or more second reference signals such that a channel characteristic of a downlink channel between the base station and the UE is within a range of the target value; and transmitting, to the UE, the one or more second reference signals.

Aspect 16: The method of aspect 15, further comprising: determining a quantized value of the estimated value of the channel characteristic of the uplink channel, wherein the quantized value of the estimated value comprises the target value of the channel characteristic of the uplink channel.

Aspect 17: The method of any of aspects 15 through 16, further comprising: selecting the target value of the channel characteristic of the uplink channel from a set of values, wherein the set of values is stored at the base station and each value of the set of values corresponds to a different set of secret key bits.

Aspect 18: The method of any of aspects 15 through 17, wherein generating the set of secret key bits comprises: determining a mapping between the target value of the channel characteristic of the uplink channel and the set of secret key bits

Aspect 19: The method of any of aspects 15 through 18, wherein generating the set of secret key bits comprises: inputting the target value of the channel characteristic of the uplink channel into a function to generate a set of output values; and converting the set of output values into the set of secret key bits.

Aspect 20: The method of any of aspects 15 through 19, wherein generating the one or more second reference signals comprises: applying a frequency offset to the one or more second reference signals, the frequency offset based at least in part on the value of the channel characteristic of the uplink channel and the target value of the channel characteristic of the uplink channel: applying a timing offset to the one or more second reference signals, the timing offset based at least in part on the value of the channel characteristic of the uplink channel and the target value of the channel characteristic of the uplink channel: modifying a precoder corresponding to one or more ports associated with resources used to transmit the one or more first reference signals and receive the one or more second reference signals, the modifying based at least in part on the value of the channel characteristic of the uplink channel and the target value of the channel characteristic of the uplink channel: or any combination thereof.

Aspect 21: The method of any of aspects 15 through 20, wherein the channel characteristic of the uplink channel comprises a delay spread and estimating the value of the channel characteristic of the uplink channel comprises: estimating a respective CIR and a respective PDP for each port of at least two ports of the base station, wherein the at least two ports are used by the base station to receive the one or more first reference signals.

Aspect 22: The method of aspect 21, wherein generating the one or more second reference signals comprises: applying a cyclic shift to the one or more second reference signals based at least in part on the estimated respective CIR and the estimated respective PDP for each port of the at least two ports.

Aspect 23: The method of any of aspects 15 through 22, further comprising: transmitting, to the UE, signaling that indicates the channel characteristic of the downlink channel, a set of resources for the UE to use to receive the one or more second reference signals, or both.

Aspect 24: The method of aspect 23, wherein the signaling indicates the set of resources, the method further comprising: transmitting, to the UE, an indication of a repetition factor for the one or more second reference signals, the repetition factor identifying a quantity of the or more second reference signals to be received by the UE over the set of resources.

Aspect 25: The method of aspect 24, wherein the set of resources comprises a portion of resources of a single slot or multiple slots.

Aspect 26: The method of any of aspects 15 through 25, further comprising: receiving, from the UE, an indication of a phase difference between transmitting a first signal via a port of the UE and receiving a second signal via the port of the UE, wherein the port is used by the UE to transmit the one or more first reference signals and receive the one or more second reference signals, and wherein generating the one or more second reference signals is based at least in part on the phase difference.

Aspect 27: The method of any of aspects 15 through 26, further comprising: determining a QCL relationship between one or more ports used to receive the one or more first reference signals and one or more ports used to transmit the one or more second reference signals, wherein estimating the value of the channel characteristic of the uplink channel is based at least in part on the QCL relationship.

Aspect 28: The method of any of aspects 15 through 27, further comprising: transmitting, to the UE, signaling instructing the UE to obtain the set of secret key bits based at least in part on estimating a value of the channel characteristic of the downlink channel when the UE operates according to an FDD scheme.

Aspect 29: The method of any of aspects 15 through 28, further comprising: transmitting, to the UE, control signaling indicating a set of modes for key extraction that comprises at least a first mode and a second mode different from the first mode, wherein the first mode corresponds to the UE generating the set of secret key bits based at least in part on estimating a value of the channel characteristic of the downlink channel; and transmitting, to the UE, an indication to perform secret key extraction according to the first mode.

Aspect 30: The method of any of aspects 15 through 29, wherein the channel characteristic of the uplink channel is based at least in part on a frequency dispersion or a time dispersion of the one or more first reference signals as received by the base station.

Aspect 31: The method of aspect 30, wherein the channel characteristic of the uplink channel comprises a delay spread, a doppler shift, or a doppler spread of the one or more first reference signals as received by the base station.

Aspect 32: The method of any of aspects 15 through 31, wherein the uplink channel corresponds to a first frequency range and the downlink channel corresponds to a second frequency range, the first frequency range different from the second frequency range.

Aspect 33: An apparatus for wireless communication at a UE, comprising memory, a transceiver, and at least one processor coupled with the memory and the transceiver, the at least one processor configured to cause the apparatus to perform a method of any of aspects 1 through 14.

Aspect 34: An apparatus for wireless communication at a UE, comprising at least one means for performing a method of any of aspects 1 through 14.

Aspect 35: A non-transitory computer-readable medium storing code for wireless communication at a UE, the code comprising instructions executable by a processor to perform a method of any of aspects 1 through 14.

Aspect 36: An apparatus for wireless communication at a base station, comprising memory, a transceiver, and at least one processor coupled with the memory and the transceiver, the at least one processor configured to cause the apparatus to perform a method of any of aspects 15 through 32.

Aspect 37: An apparatus for wireless communication at a base station, comprising at least one means for performing a method of any of aspects 15 through 32.

Aspect 38: A non-transitory computer-readable medium storing code for wireless communication at a base station, the code comprising instructions executable by a processor to perform a method of any of aspects 15 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
transmitting, to a base station, one or more first reference signals;
receiving, from the base station in response to the one or more first reference signals, one or more second reference signals corresponding to a target value for a channel characteristic of a downlink channel between the UE and the base station;
performing channel estimation on the downlink channel based at least in part on the one or more second reference signals;
estimating a value of the channel characteristic of the downlink channel based at least in part on performing the channel estimation; and
generating a set of secret key bits based at least in part on the estimated value being within a range of the target value.

2. The method of claim 1, further comprising:
determining a quantized value of the estimated value of the channel characteristic, wherein the quantized value comprises the target value.

3. The method of claim 1, wherein generating the set of secret key bits comprises:
determining a mapping between the target value and the set of secret key bits; or
inputting the target value into a function to generate a set of output values, and converting the set of output values into the set of secret key bits.

4. The method of claim 1, further comprising:
receiving, from the base station, signaling that indicates the channel characteristic of the downlink channel, a set of resources for receiving the one or more second reference signals, or both.

5. The method of claim 4, wherein the signaling indicates the set of resources, the method further comprising:
receiving, from the base station, an indication of a repetition factor for the one or more second reference signals, wherein the repetition factor identifies a quantity of the one or more second reference signals that are to be received over the set of resources, and wherein the set of resources comprises a portion of resources of a single slot or multiple slots.

6. The method of claim 1, further comprising:
determining a phase difference between transmitting a first signal via a port of the UE and receiving a second signal via the port of the UE, wherein the port is used by the UE to transmit the one or more first reference signals and receive the one or more second reference signals; and
transmitting, to the base station, an indication of the phase difference.

7. The method of claim 1, further comprising:
determining a quasi-colocation relationship between one or more ports of the UE used to transmit the one or more first reference signals and one or more ports of the UE used to receive the one or more second reference signals, wherein estimating the value of the channel characteristic is based at least in part on the quasi-colocation relationship.

8. The method of claim 1, further comprising:
receiving, from the base station, signaling instructing the UE to generate the set of secret key bits based at least in part on estimating the value of the channel characteristic when the UE operates according to a frequency division duplexing scheme.

9. The method of claim 1, further comprising:
receiving, from the base station, control signaling indicating a set of modes for key extraction that comprises at least a first mode and a second mode different from the first mode, wherein the first mode corresponds to the UE generating the set of secret key bits based at least in part on estimating the value of the channel characteristic; and
receiving, from the base station, an indication to perform secret key extraction according to the first mode.

10. The method of claim 1, wherein the channel characteristic is based at least in part on a frequency dispersion or a time dispersion of the one or more second reference signals as received by the UE.

11. The method of claim 10, wherein the channel characteristic comprises a delay spread, a doppler shift, or a doppler spread of the one or more second reference signals as received by the UE.

12. The method of claim 1, wherein an uplink channel between the UE and the base station corresponds to a first frequency range and the downlink channel corresponds to a second frequency range, the first frequency range different from the second frequency range.

13. A method for wireless communication at a base station, comprising:
receiving one or more first reference signals from a user equipment (UE);
performing channel estimation on an uplink channel between the UE and the base station based at least in part on the one or more first reference signals;
estimating a value of a channel characteristic of the uplink channel based at least in part on performing the channel estimation;
generating a set of secret key bits based at least in part on a target value of the channel characteristic of the uplink channel;
generating, based at least in part on the estimated value and the target value, one or more second reference signals such that a channel characteristic of a downlink channel between the base station and the UE is within a range of the target value; and
transmitting, to the UE, the one or more second reference signals.

14. The method of claim 13, further comprising:
determining a quantized value of the estimated value of the channel characteristic of the uplink channel, wherein the quantized value of the estimated value comprises the target value of the channel characteristic of the uplink channel.

15. The method of claim 13, further comprising:
selecting the target value of the channel characteristic of the uplink channel from a set of values, wherein the set of values is stored at the base station and each value of the set of values corresponds to a different set of secret key bits.

16. The method of claim 13, wherein generating the set of secret key bits comprises:
determining a mapping between the target value of the channel characteristic of the uplink channel and the set of secret key bits; or
inputting the target value of the channel characteristic of the uplink channel into a function to generate a set of output values, and converting the set of output values into the set of secret key bits.

17. The method of claim 13, wherein generating the one or more second reference signals comprises:
applying a frequency offset to the one or more second reference signals, the frequency offset based at least in part on the value of the channel characteristic of the uplink channel and the target value of the channel characteristic of the uplink channel;
applying a timing offset to the one or more second reference signals, the timing offset based at least in part on the value of the channel characteristic of the uplink channel and the target value of the channel characteristic of the uplink channel;
modifying a precoder corresponding to one or more ports associated with resources used to transmit the one or more first reference signals and receive the one or more second reference signals, the modifying based at least in part on the value of the channel characteristic of the uplink channel and the target value of the channel characteristic of the uplink channel; or
any combination thereof.

18. The method of claim 13, wherein the channel characteristic of the uplink channel comprises a delay spread and estimating the value of the channel characteristic of the uplink channel comprises:
estimating a respective channel impulse response and a respective power delay profile for each port of at least two ports of the base station, wherein the at least two ports are used by the base station to receive the one or more first reference signals; and
applying a cyclic shift to the one or more second reference signals based at least in part on the estimated respective channel impulse response and the estimated respective power delay profile for each port of the at least two ports.

19. The method of claim 13, further comprising:
transmitting, to the UE, signaling that indicates the channel characteristic of the downlink channel, a set of resources for the UE to use to receive the one or more second reference signals, or both.

20. The method of claim 19, wherein the signaling indicates the set of resources, the method further comprising:
transmitting, to the UE, an indication of a repetition factor for the one or more second reference signals, the repetition factor identifying a quantity of the or more second reference signals to be received by the UE over the set of resources.

21. The method of claim 20, wherein the set of resources comprises a portion of resources of a single slot or multiple slots.

22. The method of claim 13, further comprising:
receiving, from the UE, an indication of a phase difference between transmitting a first signal via a port of the UE and receiving a second signal via the port of the UE, wherein the port is used by the UE to transmit the one or more first reference signals and receive the one or more second reference signals, and wherein generating the one or more second reference signals is based at least in part on the phase difference.

23. The method of claim 13, further comprising:
transmitting, to the UE, control signaling indicating a set of modes for key extraction that comprises at least a first mode and a second mode different from the first mode, wherein the first mode corresponds to the UE generating the set of secret key bits based at least in part on estimating a value of the channel characteristic of the downlink channel; and
transmitting, to the UE, an indication to perform secret key extraction according to the first mode.

24. An apparatus for wireless communication, comprising:
memory;
a transceiver; and
at least one processor of a user equipment (UE), the at least one processor coupled with the memory and the transceiver, and the at least one processor configured to cause the apparatus to:
transmit, via the transceiver and to a base station, one or more first reference signals;
receive, via the transceiver and from the base station in response to the one or more first reference signals, one or more second reference signals corresponding to a target value for a channel characteristic of a downlink channel between the UE and the base station;
perform channel estimation on the downlink channel based at least in part on the one or more second reference signals;
estimate a value of the channel characteristic of the downlink channel based at least in part on performing the channel estimation; and
generate a set of secret key bits based at least in part on the estimated value being within a range of the target value.

25. The apparatus of claim 24, the at least one processor further configured to cause the apparatus to:
determine a quantized value of the estimated value of the channel characteristic, wherein the quantized value comprises the target value.

26. The apparatus of claim 24, wherein, to generate the set of secret key bits, the at least one processor is configured to cause the apparatus to:
determine a mapping between the target value and the set of secret key bits; or
input the target value into a function to generate a set of output values, and convert the set of output values into the set of secret key bits.

27. The apparatus of claim 24, the at least one processor further configured to cause the apparatus to:
determine a phase difference between transmitting a first signal via a port of the UE and receiving a second signal via the port of the UE, wherein the port is used by the UE to transmit the one or more first reference signals and receive the one or more second reference signals; and
transmit, via the transceiver and to the base station, an indication of the phase difference.

28. An apparatus for wireless communication, comprising:
memory;
a transceiver; and
at least one processor of a base station, the at least one processor coupled with the memory and the transceiver, and the at least one processor configured to cause the apparatus to:
receive, via the transceiver, one or more first reference signals from a user equipment (UE);
perform channel estimation on an uplink channel between the UE and the base station based at least in part on the one or more first reference signals;
estimate a value of a channel characteristic of the uplink channel based at least in part on performing the channel estimation;
generate a set of secret key bits based at least in part on a target value of the channel characteristic of the uplink channel;
generate, based at least in part on the estimated value and the target value, one or more second reference signals such that a channel characteristic of a downlink channel between the base station and the UE is within a range of the target value; and
transmit, to the UE, the one or more second reference signals.

29. The apparatus of claim 28, the at least one processor further configured to cause the apparatus to:
determine a quantized value of the estimated value of the channel characteristic of the uplink channel, wherein the quantized value of the estimated value comprises the target value of the channel characteristic of the uplink channel.

30. The apparatus of claim 28, the at least one processor further configured to cause the apparatus to:
select the target value of the channel characteristic of the uplink channel from a set of values, wherein the set of values is stored at the base station and each value of the set of values corresponds to a different set of secret key bits.
